(19) United States
(12) Patent Application Publication
(10) Pub. No.: US 2010/0158005 A1
(43) Pub. Date: Jun. 24, 2010

(54) System-On-a-Chip and Multi-Chip Systems Supporting Advanced Telecommunication Functions

(76) Inventors: Suvhasis Mukhopadhyay, Shrewsbury, MA (US); Marco Heddes, Oxford, CT (US); Massimo Ravasi, Lausanne (CH); Michael Singngee Yeo, Shelton, CT (US)

Correspondence Address: GORDON & JACOBSON, P.C., 60 LONG RIDGE ROAD, SUITE 407, STAMFORD, CT, 06902, US

(21) Appl. No.: 12/342,625

(22) Filed: Dec. 23, 2008

(51) Int. Cl. H04L 12/56

(52) U.S. Cl. 370/392; 370/412

(57) ABSTRACT

A system-on-chip integrated circuit (and multi-chip systems based thereon) that includes a bridge interface that provides transparent bridging of data communicated between integrated circuits.

### BACKGROUND OF THE INVENTION

1. FIELD OF THE INVENTION

This invention relates to system-on-a-chip products employing parallel processing architectures. More specifically, the invention relates to such system-on-a-chip products implementing a wide variety of functions, including telecommunications functionality that is necessary and/or desirable in next generation telecommunications networks.

2. STATE OF THE ART

For many years, Moore's law has been exploited by the computer industry by increasing the processor's clock speed and by more sophisticated processor architectures, while maintaining the sequential programming model. Currently, it is well accepted that this approach is now hitting the so called power-wall and that future architectures must be based on multi processor cores.

An application domain that is very suitable for parallel computing architectures are global telecommunication networks. In particular the mobile backhaul network is constantly evolving as new technologies become available. Presently, the mobile backhaul networks comprises a mixture of various protocols and transport technologies, including PDH (T1/E1), Sonet/SDH, ATM. More recently, with the enormous increase in required bandwidth (for example triggered by iPhones and similar devices) as well as the high operational cost of legacy transport technologies (like PDH), it is expected that the mobile backhaul network will migrate to Carrier Ethernet technologies. However, existing mobile phone services, like 2G, 2.5G and 3G will co-exist with new technologies like 4G and LTE. This means that legacy traffic, generated by the older technologies, will have to be transported over the mobile backhaul network.

With these changes to the mobile backhaul network, there will be many challenges. For example, the co-existence of legacy traffic and new traffic type leads requires a variety of interworking functions to be performed in the network—for example to map T1/E1 traffic onto Carrier Ethernet (called circuit emulation). Furthermore, it is required that network equipment can support all these variety of traffic types with associated interworking functions. And it is expected that the network equipment can be remotely upgraded (e.g. by downloading a new software load) so that future configurations will for example allocate less processing resources for legacy traffic and more processing resources for Ethernet traffic.

### SUMMARY OF THE INVENTION

The present invention is an integrated circuit (and multi-chip systems based thereon) that include an array of nodes linked by an on-chip communication network. A bridge interface is operably coupled to the on-chip communication network. The bridge interface provides for transparent bridging of data communicated over at least one physical communication channel that links the integrated circuit to at least one other integrated circuit.

In the preferred embodiment, the nodes of the integrated circuit include an array of programmable processing elements as well as peripheral blocks that provide support for processing telecommunication signals, such as recovering timing signals from packetized data streams representing standard telecommunication circuit signals, buffering packetized data such as Ethernet packet data, and receiving and transmitting SONET signals.

Additional objects and advantages of the invention will become apparent to those skilled in the art upon reference to the detailed description taken in conjunction with the provided figures.

### BRIEF DESCRIPTION OF THE DRAWINGS

FIG. 1 is a high level function block diagram of a system-on-a-chip (SOC) integrated circuit in accordance with the present invention; the SOC integrated circuit includes a network-on-chip (NOC) that provides for any-to-any message communication between the processing elements and other peripheral blocks of the SOC integrated circuit.

FIG. 2A is a schematic diagram of operations for constructing messages carried on the NoC of FIG. 1 from packetized data in accordance with the present invention.

FIG. 2B is a schematic diagram of a data message format carried on the NoC of FIG. 1 in accordance with the present invention.

FIG. 2C is a schematic diagram of a flow control message format carried on the NoC of FIG. 1 in accordance with the present invention.

FIG. 2D is a schematic diagram of an interrupt message format carried on the NoC of FIG. 1 in accordance with the present invention.

FIG. 2E1 is a schematic diagram of a configuration message format carried on the NoC of FIG. 1 in accordance with the present invention.

FIG. 2E2 is a schematic diagram of a configuration reply message format carried on the NoC of FIG. 1 in accordance with the present invention.

FIGS. 2F1 and 2F2 are schematic diagrams of a shared-resource message format carried on the NoC of FIG. 1 in accordance with the present invention.

FIGS. 2G is a schematic diagram of a shared-memory message format carried on the NoC of FIG. 1 in accordance with the present invention.

FIG. 3A is a diagram illustrating exemplary signaling for the bus links of the NoC of FIG. 1 in accordance with the present invention.

FIG. 3B is a functional block diagram of an exemplary architecture for realizing the switch elements of the SOC of FIG. 1 in accordance with the present invention.

FIG. 4A is a functional block diagram of an exemplary architecture for realizing a NoC-Node interface that is common part used by the nodes of the SOC of FIG. 1 in accordance with the present invention; the NoC-node interface connects the given node to the bus links of the NoC.

FIG. 4B is a schematic diagram of the incoming side RAMs of FIG. 4A.

FIG. 4C is a schematic diagram of the TX_CHANNEL_TBL maintained by the outgoing side data message encoder of FIG. 4A.

FIG. 4D is a schematic diagram of the RX_CHANNEL_TBL maintained by the control side message encoder of FIG. 4A.

FIG. 5 is a functional block diagram of an exemplary architecture for realizing the processing elements of the SOC of FIG. 1 in accordance with the present invention.

FIGS. 6A and 6B are flow charts that illustrate the processing of incoming interrupt messages received by the processing element of FIG. 5 in accordance with the present invention.

FIG. 7 is a schematic diagram that illustrates a mechanism that maps processing cores to threads for the processing element of FIG. 5 in order to support configurable SMP processing and configurable thread prioritization in accordance with the present invention.

FIG. 8 is a schematic diagram that illustrates the software environment of the processing element of FIG. 5 in accordance with the present invention.

FIGS. 9A and 9B are schematic diagrams that illustrate an exemplary microarchitecture for realizing the NoC Bridge of FIG. 1 in accordance with the present invention.

FIG. 9C is a schematic diagram that illustrates the NoC Bridge of FIGS. 9A and 9B for interconnecting two SOC integrated circuits of FIG. 1 in accordance with the present invention.

### DETAILED DESCRIPTION OF THE PREFERRED EMBODIMENTS

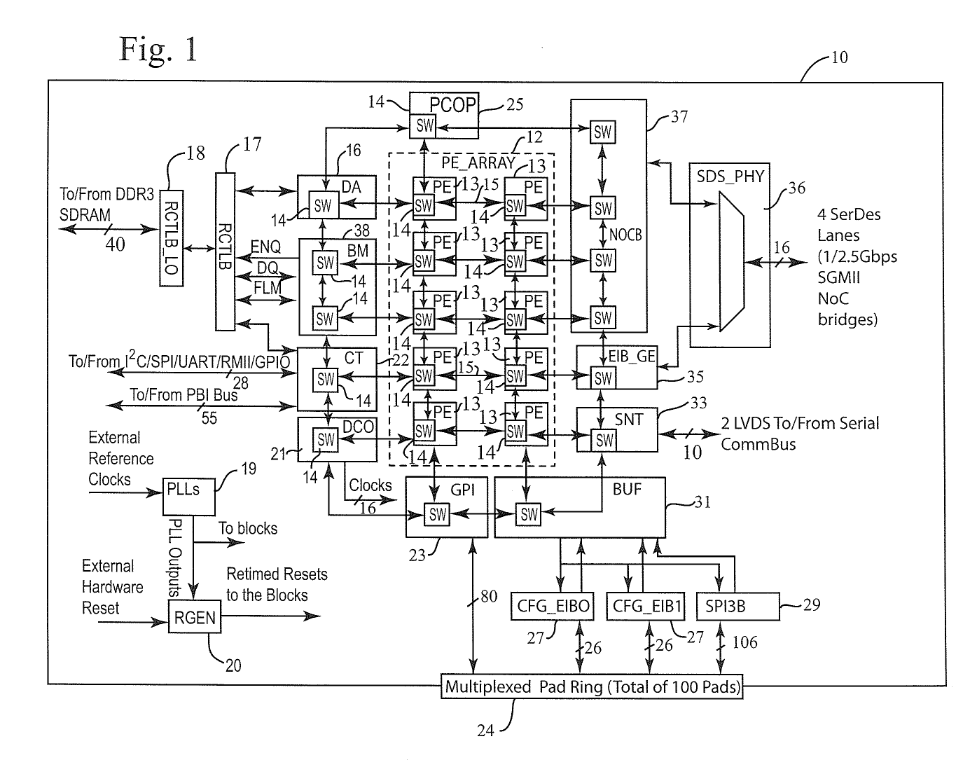

Turning now to FIG. 1, a system-on-a-chip (SOC) integrated circuit 10 according to the invention includes an array 12 of programmable processing elements 13 (for example, ten shown and labeled PE) coupled to each other by a network on chip (“NoC”). In the preferred embodiment, the NoC is organized in a 2-D mesh topology with plurality of switch elements 14 each interfacing to a corresponding PE 13 (or other peripheral block as described below) and point-to-point bidirectional links 15 (shown as double headed arrows in FIG. 1) connecting the switch elements 14. Each switch element 14 connects to five point-to-point bidirectional links with four of the bidirectional links connecting to the neighboring switch elements and the other bidirectional link (not shown in FIG. 1) connecting to the PE 13 or other peripheral block (collectively referred to as a node) associated with the switch element. Note that in FIG. 1, some of the switch elements 14 are shown as connecting to three neighboring switch elements. It is possible that such unused connections can be used to realize a Torus architecture for the 2-D mesh topology of the NoC. It is also contemplated that the NoC can be realized by other suitable network topologies, such as a linear array, ring, star, tree, honeycomb, 3-D mesh, hypercube, etc.

The switch elements 14 communicate messages over the NoC. Each message includes a header that contains routing information that is used by the switch elements 14 to route the message at the switch elements 14. The message (or a portion thereof) is forwarded to a neighboring switch element (or to PE or peripheral block) if resources are available. It is contemplated that the switch elements 14 can employ a variety of switching techniques. For example, wormhole switching techniques can be used. In wormhole switching, the message is broken into small pieces. Routing information contained in the message header is used to assign the message to an outgoing switch port for the pieces of the message over the length of the message. Store and forward switching techniques can also be used where the switch element buffers the entire message before forwarding it on. Alternatively, circuit switching techniques can be used where a circuit (or channel) that traverses the switch elements of the NoC is built for a message and used to communicate the message over the NoC. When communication of the message is complete, the circuit is torn down.

The task of routing a given message over the NoC involves determining a path over the NoC for the given message. Such routing can be carried out in a variety of different ways, which are commonly divided into two classes: deterministic routing and adaptive routing. In deterministic routing, the routes between given pairs of network nodes are pre-programmed, i.e., are determined, in advance of transmission. Three deterministic routing schemes are commonly applied in practice, including source routing, dimension-ordered routing, table-lookup routing and interval routing. In source routing, the entire path to the destination is known to the sender and is included in the header. In dimension-ordered routing, an offset is determined for each dimension between the current node and the destination node. The message is output to the neighboring node along the dimension with the lowest offset until reaches it reaches a certain co-ordinate of that dimension. At this node, the message proceeds along another dimension with the next lowest offset. Deadlock-free routing is guaranteed if the dimensions are strictly ordered. In table-lookup routing, each node maintains a routing table that identifies the neighboring node to which the message should be forwarded for the given destination node of the message. Interval labeling is a special case of table-lookup routing in which each output channel of a node is associated with an interval. Adaptive routing determines routes to a destination node in a manner that adapts a change in conditions. The adaptation is intended to allow as many routes as possible to remain valid (that is, have destinations that can be reached) in response to the change.

Each PE 13 provides a programmable processing platform that includes a communications interface to the NoC, local memory for storing instructions and data, and processing means for processing the instructions and data stored in the local memory. The PE 13 is programmable by the loading of instructions and data into the local memory of the PE for processing by the processing means of the PE. The PEs 13 of the array 12 generally work in an asynchronous and independent manner. Interaction amongst the PEs 13 is carried out by sending messages between the PEs 13. In this manner, the array 12 represents a distributed memory MIMD (Multiple Instruction Stream, Multiple Data stream) architecture as is well known in the art.

The SOC 10 also preferably includes a clock signal generator block 19, labeled PLL, which interfaces to off-chip reference clock generator(s) and operates to generate a plurality of clock signals for supply to the on-chip circuit blocks as needed. The SOC also preferably includes a reset signal generator block 20 that interfaces to an off-chip hardware reset mechanism and operates to retime the external hardware reset signal to a plurality of reset signals for different clock domains for supply to the on-chip circuit blocks as needed.

The NoC (e.g., switch elements 14 and point-to-point bus segments 15) can also connect to other functionality realized on the SOC integrated circuit 10. Such functionality, which is referred to herein as a peripheral block, can include one or more of the following peripheral blocks as described below.

For example, the peripheral block(s) of the SOC 10 can include a memory interface to a system-level memory subsystem. In the preferred embodiment shown, such a memory interface is realized by a SDRAM access controller 16, labeled DA, that interfaces to an SDRAM protocol controller 17, labeled RCTLB, coupled to a SDRAM physical control interface 18, labeled RCTLB_L0, for interfacing to off-chip SDRAM (not shown). Other memory interfaces can be used such as DDR SDRAM, RLDRAM, etc.

In another example, the peripheral block(s) of the SOC 10 can include a digital controlled oscillator block 21, incorporating a number (e.g., up to 16) independent DCO channels, labeled DCO, that generates clock signals, based on recovered embedded timing information carried in input messages, independently for each channel, and received over the NoC, from functionality that recovers embedded timing information, using Adaptive or Differential clock recovery techniques, from a number of independent packetized data streams, such as provided in circuit emulation services well known in the telecommunications arts. The generated clock signals are output from the DCO 21 for supply to on-chip to independent physical interface circuits as needed; the operations of the DCO block 21 for generation of clock signals is controlled by messages communicated thereto over the NoC.

The peripheral block(s) of the SOC 10 can also include a control processor 22, labeled CT that controls booting of the PEs 13 of the array 12 and also triggers programming of the PEs 13 by loading instruction sequences and possibly data to the PEs 13. The control processor 22 can also execute configuration of the devices of the system preferably by configuration messages and/or VCI transactions communicated over the NoC. VCI transactions conform to a Virtual Component Interface, which is a request-response protocol well known in the communications arts. The control processor 22 can also perform various control and management operations as needed; the control processor 22 also provides an interface to off-chip devices via common processor peripheral interfaces such as a UART interface, SPI interface, I²C interface, RMII interface, and/or PBI interface; in the preferred embodiment, the control processor 22 is realized by a processor core that implements a RISC-type processing engine (such as the MIPS32 34 kec processor core sold commercially by MIPS Technologies, Inc. of Mountain View, Calif.).

The peripheral block(s) of the SOC 10 can also include a general purpose interface block 23, labeled GPI, which provides a number of configurable I/O interfaces, which preferably support a variety of communication frameworks that are common in communication devices. In the preferred embodiment, the I/O interfaces include a plurality of low-order Plesiochronous Digital Hierarchy (PDH) interfaces (such as sixteen T1, J1 or E1 interfaces), one or more high-order PDH interfaces (such as two DS3 or E3 interfaces), a plurality of computer telephony interfaces (such as eight interfaces supporting the Multi-vendor Integration protocol (MVIP) or the High-Speed Multi Vendor Interface Protocol (HMVIP) or the H.100 protocol), and a plurality of I²C interfaces (such as 16 I²C interfaces). The operations of the GPI block 23 are controlled by messages communicated thereto over the NoC.

The peripheral block(s) of the SOC 10 can also include one or more polynomial co-processor blocks 25, labeled PCOP, for carrying out a dedicated set of operations on data communicated thereto over the NoC. In the preferred embodiment, the operations include payload and header operations such as cyclic redundancy check (CRC) checking/generation, frame check sequence (FCS) checking/generation, scrambling and/or descrambling operations, payload stuffing and/or de-stuffing operations, header error control (HEC) for framing (such as for generic framing procedure (GFP)), high-level data link control (HDLC) processing, and pseudorandom binary sequence (PRBS) generation and analysis.

The peripheral block(s) of the SOC 10 can also include one or more Ethernet interface blocks 27, labeled CFG_EIB, that provide one or more bidirectional Ethernet ports widely used in communications devices. In the preferred embodiment, the Ethernet interface blocks 27 provide a plurality of full or half duplex Serial Media Independent Interface (SMII) ports, one or more Gigabit Media Independent Interface (GMII) ports, one or more Media Independent Interface (MII) ports, and one or more Reduced Gigabit Media Independent Interface (RGMII) ports.

The peripheral block(s) of the SOC 10 can also include one or more System Packet Interface (SPI) blocks 29, labeled SPI3B, which provide a channelized packet interface. In the preferred embodiment, the SPI block 29 provides an SPI Level 3 interface widely used in communications devices.

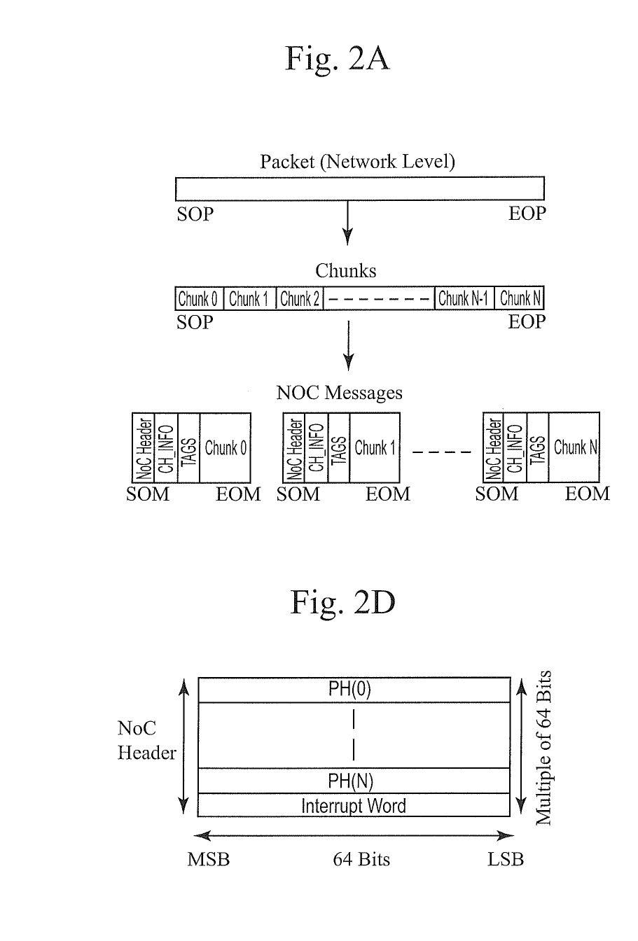

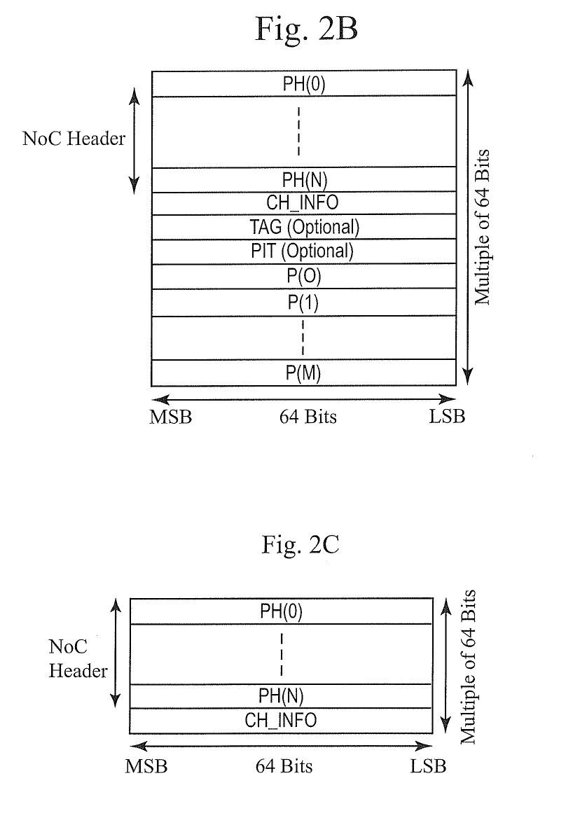

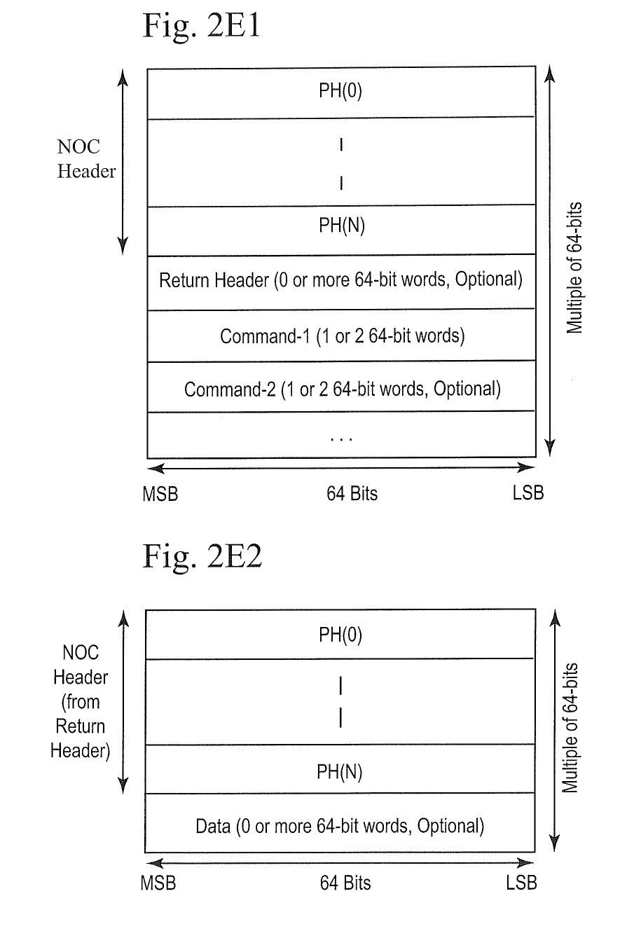

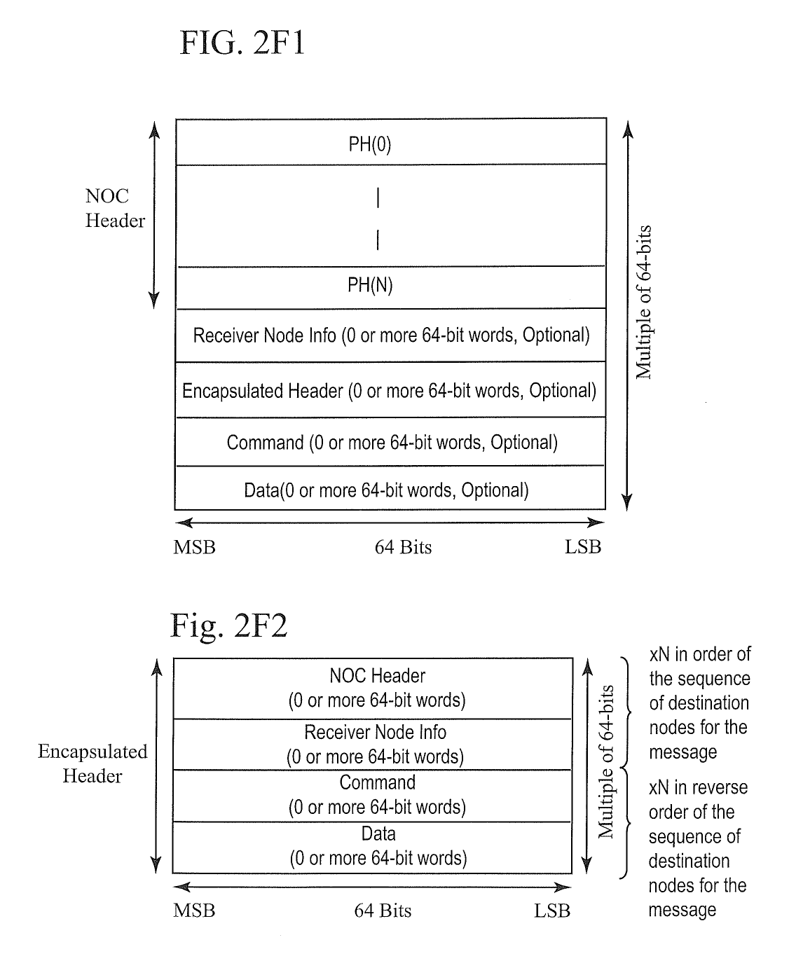

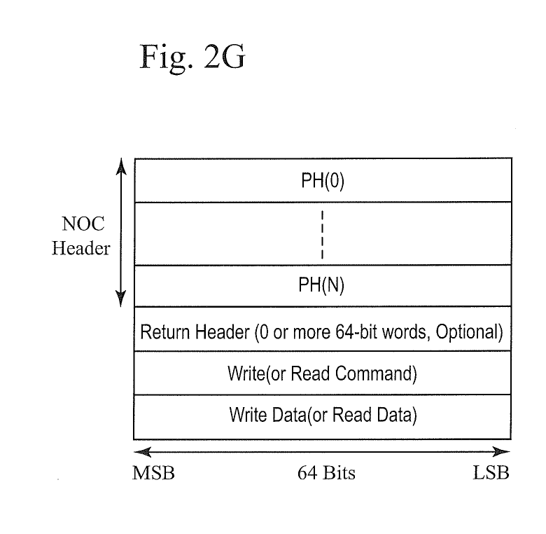

The peripheral block(s) of the SOC 10 can also include a buffer block 31, labeled BUF, that interfaces the Ethernet interface block(s) 27 and SPI block(s) 29 to the NoC. The buffer block 31 temporarily stores ingress data received over the Ethernet interface block(s) 27 and SPI block(s) 29 and fragments the buffered ingress data into chunks that are carried in messages communicated over the NoC (FIG. 2A). The destination addresses and communication channel for such messages is controlled by control messages (for example, flow control messages and/or start-up configuration messages) communicated to the buffer block 31 over the NoC. The buffer block 31 also receives chunks of data carried in messages communicated over the NoC for output over the Ethernet interface block(s) 27 and SPI block(s) 29, temporarily stores such egress data and transfers the stored egress data to the appropriate Ethernet interface block(s) 27 and SPI block(s) 29.

The peripheral block(s) of the SOC 10 can also include a SONET interface block 33, labeled SNT, which interfaces to a bidirectional serial link (preferably realized by one or more low voltage differential signaling links) that receives and transmits serial data that is part of ingress or egress SONET frames (e.g., OC-3 or OC-12 frames). In the ingress direction, the serial link carries the data recovered from an ingress SONET frame and the SONET interface block 33 fragments such data into chunks that are carried in messages communicated over the NoC (FIG. 2A). The destination addresses and communication channel for such messages is controlled by control messages (for example, flow control messages and/or start-up configuration messages) communicated to the SONET interface block 33 over the NoC. In the egress direction, the SONET interface block 33 receives chunks of data carried in messages communicated over the NoC and transmits such data over the serial link for integration into an egress SONET frame.

The peripheral block(s) of the SOC 10 can also include a Gigabit Ethernet Interface block 35, labeled EIB_GE, that cooperates with a Physical Serializer/Deserializer block 36, labeled SDS_PHY, to support a plurality of serial Gigabit Ethernet ports (or possibly one or more 10 Gigabit Ethernet XAUI port). In the ingress direction, the block 36 receives data over multiple serial channels, recovers clock and data signals from the multiple channels, deserializes the recovered data, and outputs the deserialized data to the Gigabit Interface block 35. The Gigabit Interface block 35 performs 8B/10B decoding of the deserialized data supplied thereto and Ethernet link layer processing of the decoded data. The resultant data is buffered (preferably in a FIFO buffer assigned to a given port) and fragmented into chunks that are carried in messages communicated over the NoC (FIG. 2A). The destination addresses and communication channel for such messages is controlled by control messages (for example, flow control messages and/or start-up configuration messages) communicated to the Gigabit Ethernet Interface block 35 over the NoC. In the egress direction, the Gigabit Ethernet Interface block 35 receives chunks of data carried in messages communicated over the NoC and buffers such data (preferably in a FIFO buffer assigned to a given port). The buffered data is subject to Ethernet link layer processing followed by 8B/10B encoding. The resultant encoded data is output to Block 36, which serializes the encoded data and transmits the serialized encoded data over multiple serial channels.

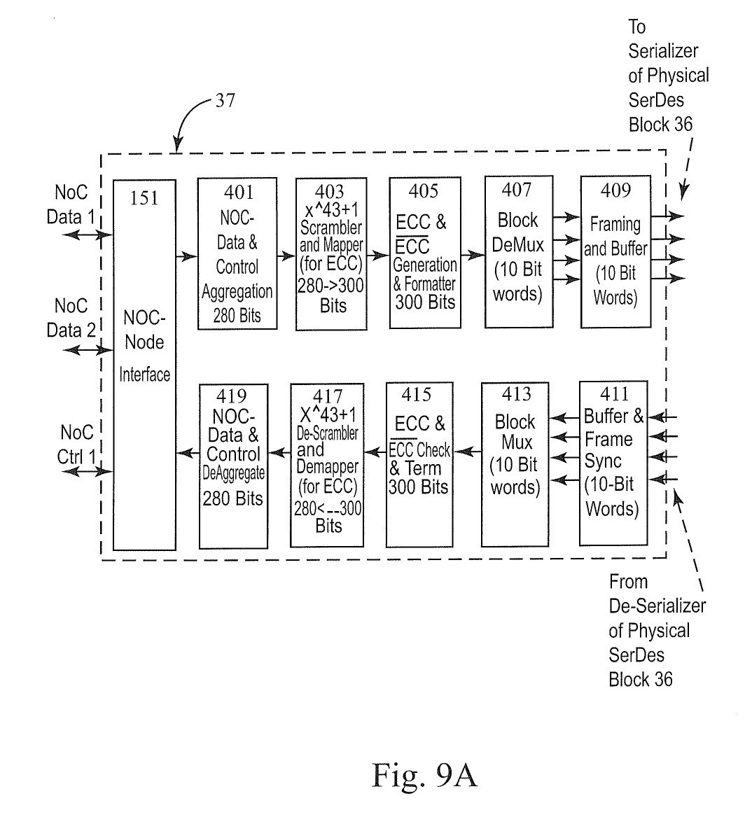

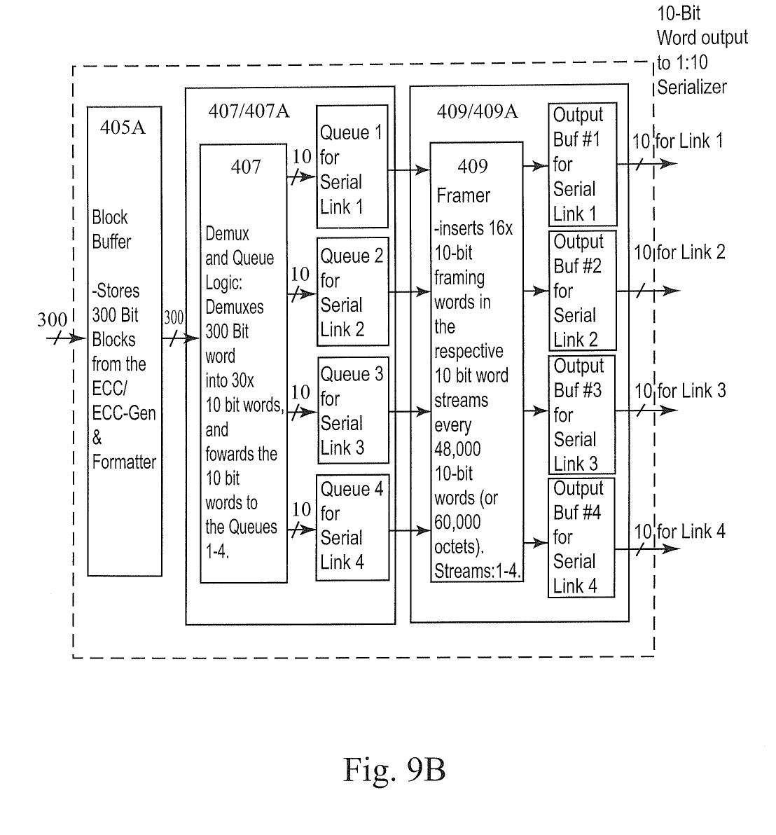

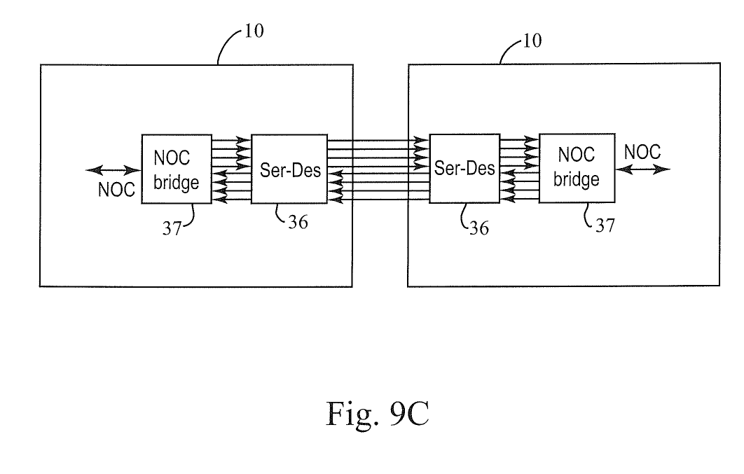

The peripheral block(s) of the SOC 10 can also include a bridge 37, labeled NoCB, that cooperates with the Physical Serializer/Deserializer block 36 to support interconnection of the SOC 10 to one or more other SOCs 10 or connection to other external equipment. In the preferred embodiment, the bridge 37 may be transparent to the nodes of the interconnected SOCs. In particular, the bridge 37 may examine the NOC header words of the NOC messages communicated thereto over the NOC and forward such NOC messages to the other SOC interconnected thereto in the event that the route encoded by the NOC headers words dictates such forwarding. Alternatively, a routing table or similar data structure can be used to route the NOC message over to the interconnected SOC depending upon the destination address of the message. A more detailed description of an exemplary embodiment of the bridge 37 is described below with reference to FIGS. 9A through 9C.

The peripheral block(s) of the SOC 10 can also include a Buffer Manager 38, labeled BM, that provides support for buffering of packets in external memory. External memory is frequently used for storage of packets to achieve several objectives.

First, the external memory provides intermediate storage when multiple stages of processing are to be performed within the system. Each stage operates on the packet and passes it to the next stage.

Second, the external memory provides deep elastic storage of many packets which arrive from a Receive interface at a higher rate than they can be sent on a transmit interface.

Third, the external memory supports the implementation of priority based scheduling of outbound packets that are waiting to be sent on a transmit interface.

To support the buffering of packets in external memory, the BM provides support for packet queues which are First-In-First-Out (FIFO) structures. Multiple packets can be stored to a queue and the BM provides Read operations and Write operations on the queue. Read removes a packet from the queue and Write inserts a packet into the queue.

In the preferred embodiment, the packet streams processed by the Buffer Manager 38 are received and transmitted as a sequence of chunks (or fragments) carried in messages communicated over the NoC. The BM communicates to the SDRAM protocol controller 17 to perform the memory write or read operation. Packet queues are implemented in the BM and accessed by request signals for Write and Read operations (labeled ENQ and DQ). The Buffer Manager 38 receives ENQ and DQ signals from any NoC clients requiring access to queuing services of the BM. The NoC clients may be realized as hardware or software entities.

The peripheral blocks of the SOC as described above (or parts thereof) can be realized by dedicated hardware logic, a custom single purpose processor (e.g., control unit and datapath), a multipurpose processor (e.g., one or more instruction processing cores together with instructions for carrying out specified tasks), one or more of the PEs 13 of the array 12 loaded with instructions for carrying out specified tasks, other suitable circuitry, and/or any combination thereof.

The GPI block 23, the Ethernet interface block(s) 27 and the SPI block(s) 29 are preferably accessed via a multiplexed pad ring 24 that provides a plurality of user-configurable multiplexed pins (for example, 100 pins). The configuration of the multiplexed pad ring is user-configurable to support for different combinations of the said interfaces.

In the preferred embodiment, the GPI block 23 employs NRZ Data and clock signals for both the transmit and receive sides of each given low-order PDH interface. A third input indicating bi-polar violation or loss of signal can also be provided for receive side of the given low-order PDH interface. For the receive side, the clock signal is preferably recovered for the respective ingress low-order PDH channel via external line interface unit(s). For the transmit side, the clock signal can be derived from one of the following timing modes:
(a) a Loop-Timing mode in which the transmit clock is derived from the receive side clock for the same user-selected low-order PDH channel;
(b) a common external reference clock mode in which the transmit clock is supplied by an external reference clock (e.g., 1.544 MHz clock for T1 or 2.048 MHz clock for E1), which can be provided by the external line interface unit(s), an on-board oscillator based timing reference, or, a multiplier PLL, with all low-order PDH channels operating in the common external reference clock mode utilizing the same external reference clock; and
(c) Circuit Emulation over PSN mode whereby a clock is recovered for a given circuit emulated T1/E1 via the DCO block 21 and provided to the GPI block 23 for use as the transmit clock of the respective low-order PDH channel.

The GPI block 23 also employs NRZ Data and clock signals for both the transmit and receive sides of each given high-order PDH interface. A third input indicating bi-polar violation or loss of signal can also be provided for receive side of the given high-order PDH interface. For the receive side, the clock signal is preferably recovered for the ingress high-order PDH channel via external line interface unit(s). For the transmit side, the clock signal can be derived from one of the following timing modes:
(a) a Loop-Timing mode in which the transmit clock is derived from the receive side clock for the same user-selected high-order PDH; and
(b) a common external reference clock mode in which the transmit clock is provided by an external reference clock (e.g., 34.368 MHz clock for E3 or 44.736 for DS3), which can be provided by the external line interface unit(s), a multiplying PLL, or an oscillator, with all high-order PDH channels operating in the common external reference clock mode utilizing the same external reference clock.

In the preferred embodiment that GPI block 23 supports eight configurable computer telephony interfaces (e.g., MVIP/HMVIP/H.100 interfaces) that each have two bidirectional serial data signals that support a fixed number of 64 kbps time slots serially depending on the clock speed of the interface. The serial data signals are user-configurable to carry i) both data and signaling slots, ii) data and signaling slots separately, and iii) only data slots. The interfaces also include a bidirectional frame reference signal (8 KHz) and a bidirectional reference clock signal (2.048 MHz or 8.196 MHz). The reference clock signal can be used as a general timing reference for time-slot interchanging. The interfaces are configured for point-to-point operation, with each end of the link driving specified time-slots via configuration. Each interface is user configurable to be a Master or Slave of the point-to-point link. Each point-to-point interface shall be capable of operating on an independent framing reference. This frame reference shall apply to both directions of operation. It is contemplates that the computer telephony interfaces provided by the GPI block 23 can carry DS0, NxDS0, ATM and frame relay traffic that is common in communication systems.

In the preferred embodiment, the GPI block 23 supports sixteen I²C interfaces each having a bidirectional serial data signal and a clock signal. The data and signal lines of each I²C interface are preferably implemented as an open-drain output (with the line floated to Vdd to transmit a logical 1), with on-chip terminations and pull-up resistors. I/O operation shall be possible at 2.5 V. Operation of up to 2.0 Mbps is supported. Each I²C interface operates as a point-to-point link.

### Messaging Framework

The NoC carries messages that are used to communicate data and control information between the nodes connected thereto, which can include the PEs 13 of the SOC 10, the peripheral blocks of the SOC 10 as well as off-chip entities connected by the bridge 37. In the preferred embodiment, the messages carried by the NoC, referred to herein as NoC messages, are delineated by a start of message signal (SOM) and an end of message signal (EOM). The NoC messages can carry a packet, which is a network level data entity that is delimited by a start of packet (SOP) and an end of packet (EOP). For communication over the NoC, a packet is segmented into units called chunks (with a maximum chunk size) and each chunk is encapsulated inside a NoC message as illustrated in FIG. 2A.

In the preferred embodiment, the NoC messages include six types as follows:

i) data messages for communication of data across the NoC from a transmitter node (sometimes referred to as TX node) to a receiver node (sometimes referred to RX node) (FIG. 2B);

ii) flow control messages for the communication of flow control information (e.g., backpressure information) across the NoC (FIG. 2C);

iii) interrupt messages for communication of interrupt events across the NoC (FIG. 2D);

iv) configuration messages for exchange and update of configuration information across the NoC (FIGS. 2E1 and 2E2);

v) shared resource messages for sending commands over the NoC (FIG. 2F); and

vi) shared memory messages for accessing distributed shared memory resources over the NoC (FIG. 2G).

### Details of Such Message Types are Described Below in Detail.

As shown in FIG. 2B, data messages share a common format, namely one or more 64-bit header words, labeled PH(0) to PH(N) that are collectively referred to as the NoC Header, a 64-bit CH_INFO field that contains channel information, one or more optional 64-bit TAG fields for carrying application context data describing the message payload, an optional 64-bit Packet Info Tag field, labeled PIT, for carrying packet delineation information processed by peripheral blocks, and zero or more 64-bit payload words, labeled P(0) to P(M).

Each 64-bit word of the NoC header stores data that represents routing information for routing the NoC message over the NoC to the destination node. In the preferred embodiment, source routing is employed for the NoC and thus the routing information stored in the NoC header defines an entire path to the destination node. This path is defined by a sequence of hops over the NoC. In the preferred embodiment, each hop is defined by a bit pair that corresponds to a particular switch element configuration as follows:

| Incoming | Hop Bit | Switch | |
|---|---|---|---|
| Link | Pair | Configuration | Outgoing Link |
| West | 00 | Straight | East |
| West | 01 | Right | South |
| West | 10 | Left | North |
| West | 11 | Exit to Node | Node |
| South | 00 | Straight | North |
| South | 01 | Right | East |
| South | 10 | Left | West |
| South | 11 | Exit to Node | Node |
| East | 00 | Straight | West |
| East | 01 | Right | North |
| East | 10 | Left | South |
| East | 11 | Exit to Node | Node |
| North | 00 | Straight | South |
| North | 01 | Right | West |
| North | 10 | Left | East |
| Node | 00 | | West |
| Node | 01 | | South |
| Node | 10 | | North |
| Node | 11 | | East |

In the preferred embodiment, the hop bit pairs are stored in the NoC header word from right to left to represent a maximum sequence of 24 hops (2*24=48 bits of the 64-bit NoC header word), and are thus arranged in the NoC header as hop24, hop23, . . . , hop1, hop0. From the foregoing, it will be appreciated that a message originating at a node will be sent out on a switch 14 in one of four directions. Once the message has left the node where it originated, each following node in the list of routing hops will forward the message on by sending it straight, to the right, or to the left. For example, if the hop is coded 00 (straight) and arrives on the south link, it will be sent out on the north link. If the hop is coded 01 (right) and it arrives on the west link, it will be sent out on the south link. If the hop is coded 10 (left) and it arrives on the north link, it will be sent out on the east link. The last hop in the list will always be 11 which means that the message has arrived at the destination node. Before exiting a switch element at each hop, the hops in the header are right shifted so that the hop bit pair seen by the next node will be the correct next hop.

In the preferred embodiment, the sixteen most significant bits of each 64-bit NoC header word are reserved bits that are not used for routing purposes, but instead are transferred unaltered to the destination node. The reserved bits are available for use to carry transport layer and application layer information. For example, the reserved bits can define the message type (such as the data message type, flow control message type, interrupt message type, configuration Message type, shared resource message type, and shared memory message type) and carry information related thereto. The NoC header can also be extensible in format employing a variable number of 64-bit NoC header word. In this format, routes with greater than 24 hops can be supported.

In the preferred embodiment, data messages are used to transfer data over the NoC from a transmitter node to a receiver node in a communication channel. The 64-bit CH_INFO field of the data message includes a 13-bit Destination Channel ID and an optional 19-bit Destination Address. The 64-bit CH_INFO field supports both flow controlled data transfers and unchecked data transfers.

In a flow controlled data transfer, the transmitter node does not transmit the data message over the NoC before having received a notification from the receiver node that indicates a buffer is free on the receiving side and ready for storing the next message. Each transmitter node thus maintains a Transmit Channel Table that stores entries containing available receive buffer addresses at the receiver node for the respective communication channels used by the transmitter node. The CH_INFO field of the data message includes both the 13-bit Destination Channel ID and the 19-bit Destination Address. In constructing the message at the transmitter node, the 19-bit Destination Address of the message is derived by accessing the Transmit Channel Table to retrieve an entry corresponding to the Destination Channel ID of the message. When received at the receiver node, the 64-bit payload words of the data message are stored at the receiver node in the receiver buffer dictated by the 13-bit Destination Channel ID and the 19-bit Destination Address.

In an unchecked data transfer, the transmitter node transmits data without notification from the receiver node. The receiver node maintains a Receive Channel Table for each communication channel utilized by the receiver node. The Receive Channel Table includes a list of available receive buffers for storing received data for the respective communication channel. The CH_INFO field of the data message includes the 13-bit Destination Channel ID but not the 19-bit Destination Address. The receiver node accesses the Receive Channel Table corresponding to the 13-bit Destination Channel ID of the received data message to identify an available receiver buffer, and stores the 64-bit payload words of the data message at the identified receiver buffer.

As shown in FIG. 2C, flow control messages share a common format, namely one or more 64-bit header words, labeled PH(O) to PH(N) that make up the NoC Header and a 64-bit CH_INFO field that contains channel information. The NoC Header of the flow control message is identical to the NoC Header of the data message and thus includes both routing information and reserved bits as described above. In the preferred embodiment, flow-control messages are communicated from a receiver node to a transmitter node for a given communication channel to notify the transmitter node of receive buffer availability in the receiver node, for example when a new receive buffer is available at the receiver node. In this case, the 64-bit CH_INFO field of the flow control message includes a 13-bit Source Channel ID and a 19-bit Destination Address. The Source Channel ID points to the Transmit Channel Table in transmitter node for the respective communication channel. The Destination Address is the start address of the available receive buffer in the receiver node for the respective communication channel. The transmitter node employs the Source Channel ID to generate an index to a Transmit Channel Table entry corresponding to the respective communication channel for updating such Transmit Channel Table entry with the address of the available receive buffer provided by the Destination Address.

In the preferred embodiment, flow-control messages are also communicated from a receiver node to a transmitter node for a given communication channel to provide a notification of “back pressure” to the transmitter node. In this case, the 64-bit CH_INFO field of the flow control message includes a 13-bit Source Channel ID.

As shown in FIG. 2D, interrupt messages share a common format, namely one or more 64-bit header words, labeled PH(0) to PH(N) that make up the NoC Header and a 64-bit Interrupt word that contains information related to the interrupt source. The NoC Header of the interrupt message is identical to the NoC Header of the data message and thus includes both routing information and reserved bits as described above. In the preferred embodiment, two different classes of interrupt messages are supported including Interrupt-to-PE messages and Interrupt-to-Host messages. The Interrupt-to-PE messages are used to send interrupts over the NoC from a source node to a destination PE for interrupting tasks executing on the destination PE. The interrupt word for the Interrupt-to-PE message includes an identifier of an application/task specific interrupt. The destination node PE receives the Interrupt-to-PE message and generates the application/task specific hardware interrupt signal identified by the identifier of the interrupt word. The Interrupt-to-Host messages are used to send interrupt messages over the NoC from a source node to a designated host processor (such as control processor 22). The interrupt word for the Interrupt-to-Host message includes a 16-bit Interrupt ID, 16-bit Interrupt Class and a 32-bit Interrupt Info field. The 16-bit Interrupt ID uniquely identifies the source node within the system; The 16-bit Interrupt Class identifies the type of error; The 32-bit Interrupt Info field is for data associated with the interrupt condition. There is an interrupt controller inside the control processor block 22 which uses the Interrupt Class to select an Interrupt Service Routine (ISR) dedicated for servicing peripherals of a given type. The Interrupt ISR uses the Interrupt ID and Interrupt Info to handle the event condition. A typical action performed by the ISR is to schedule a control processor task responsible for managing a given peripheral. This task will then communicate with the hardware peripheral or software task running in the PE 13 to handle the condition.

As shown in FIG. 2E1, configuration messages share a common format, namely one or more 64-bit header words, labeled PH(0) to PH(N) that make up the NoC Header, an optional Return Header of one or more 64-bit words, and one or more command fields each being one or two 64-bit words. In the preferred embodiment, the command field(s) can support three different commands as dictated by a 2-bit command type subfield of the given command field, including a 64-bit read command, a 64-bit write command, and 128-bit masked-write command. The configuration messages allow for communication of such commands over the NoC between a source node and destination node. Using these transaction primitives, configuration registers can be read or written, status registers can be read and counter registers can be read. The control processor 22 functions as the central point of control for maintaining/distributing configuration, collecting status from the various sub-systems and collecting performance counters.

The 64-bit read command includes the 2-bit command type subfield (set to zero to designate the read command) and a 30-bit address field; the remaining 32 bits are unused. The destination node reads configuration data from its local memory at an address corresponding to the 30-bit address of the read command and returns the configuration data read from the local memory of the destination node in a reply message (FIG. 2E2) transmitted from the destination node to the source node over the NoC.

The 64-bit write command includes the 2-bit command type subfield (set to 1 to designate the write command), a 30-bit address field, and a 32-bit data field containing configuration data. The destination node writes the configuration data of the 32-bit data field into its local memory at an address corresponding to the 30-bit address of the write command and optionally returns an acknowledgement to the source node in a reply message (FIG. 2E2) transmitted from the destination node to the source node over the NoC.

The 128-bit masked-write command includes the 2-bit command type subfield (set to 2 to designate the masked-write command), a 30-bit address field, a 32-bit data field, and a 32-bit mask field; the remaining 32 bits are unused. The 32-bit mask field has one or more bits set to logic ‘1’ indicating each bit position to be reassigned to a new value in the 32-bit destination register. The new value of each bit position is specified in the 32-bit data field. When a reply is requested by the source node, the final updated destination register value is returned. An example of the masked-write is as follows:

Data Field=0x000000AA

Mask Field=0X000000FF

Destination register=0x11223344

The 32-bit mask field specifies ‘FF’ in the lower 8-bits indicating only these bits are to be modified. The 32-bit data field specifies ‘AA’ in the lower 8-bits indicating the new bit pattern of ‘AA’ in the lower 8-bits of the destination register. The upper bits of the destination register are ‘112233’ remain unchanged. After the masked-write operation the destination register will hold 0x112233AA and this pattern will be optionally returned to the source node along with the original register value of 0x11223344 when acknowledge is requested.

In the preferred embodiment, a reply message to the configuration command(s) that are included in a given configuration message is generated only if a Return Header (for the reply) is specified within the given configuration message request. The format of such Return Header can be freely defined by the given configuration message. As shown in FIG. 2E2, the Return Header is used as the NoC header of the reply and appended with data as defined in the following table.

| Reply Message | Data contained in Reply Message |
|---|---|
| Reply to read command | 32-bit Data |
| Reply to write command | Empty (=acknowledgement message) |
| Reply to masked-write command | 32-bit Data after Masked Write |
| | 32-bit Data before Masked Write |

In principle, the communication of configuration messages as described above can be extended to communicate VCI transactions as block of a VCI memory map. In this case, the block of the VCI memory map can be specified, for example, by a start address and number of transactions for a contiguous block or by a number of address/data pairs for a desired number of VCI memory map transactions.

As shown in FIG. 2F1, shared resource messages share a common format, namely one or more 64-bit header words, labeled PH(0) to PH(N) that make up the NoC Header, an optional Receiver Node Info field of one or more 64-bit words, an optional Encapsulated Header field of one or more 64-bit words, an optional Command field of one or more 64-bit words, and an optional Data field of one or more 64-bit words.

The Encapsulated Header supports chained communication whereby a sequence of commands (as well as data consumed and generated by the operation of such commands) are carried out over a set of nodes coupled to the NoC. This allows a PE (or other node) to send commands and data to another PE (or other node) through one or more coprocessors. In the preferred embodiment as shown in FIG. 2F2, the Encapsulated Header includes a NoC Header and Receiver Info field pair for each destination node in a sequence of N destination nodes used in the chained communication, followed by Command and Data field pairs for each destination node in such sequence. The ordering of the NoC Header and Receiver Info field pairs preferably corresponds to first-to-last ordering of the destination nodes in the sequence of destination nodes used in the chained communication, while the ordering of the Command and Data field pairs preferably corresponds to last-to-first ordering of the destination nodes in the sequence. This structure allows the encapsulated header to be efficiently pruned at a given node in the sequence by removing the top NoC Header and Receiver Info field pair corresponding to the given node and removing the bottom Command and Data field pair corresponding to the given node. Such pruning is carried out after consumption of the commands and data for the given node such that the Encapsulated Header is properly formatted for processing at the next node in the sequence.

The words of the Receiver Node Info field preferably include a 13-bit Destination Channel ID, a 19-bit Destination Address, and an optional 32-bit ID. The Destination Channel ID identifies an instance of communication to the Receiver Node. The Destination Address identifies the location to store the message in the Receiver Node. The Receiver ID is interpreted by the destination node receiving the message. For example, the destination node can store a table of NoC headers for outgoing messages indexed by Receiver ID, and the Receiver ID field of the received message used as index into this table to select the corresponding NoC header for constructing an outgoing message to the next NoC node in the chained communication.

The words of the Command field encode commands that are carried out by the destination node. Such commands are application specific and can generate result data. Each node consumes its designated command words plus command data when performing its processing. Results are made available as output result data. When result data is generated it is used to update one or more of the remaining Command fields or corresponding data fields to be propagated to the next Node of the chained communication. Thus each destination node of the chained communication can generate intermediate results used by the subsequent destination nodes and create commands for subsequent nodes. The final destination of the chained communication could be a new destination or the results can be returned to the original source node. Both cases are handled implicitly in that the command field and command data define where the data is to be forwarded. When the final destination is the source node, the last NoC header specifies the route to the original source node. The last command field and last command data carry the final data output by the chained communication.

As shown in FIG. 2G, shared memory messages share a common format, namely one or more 64-bit words, labeled PH(0) to PH(N) that make up the NoC Header, one or more 64-bit words that optionally make up a return header, a command for initiating a write or read command at the destination node, and data that is part of the write or read command. Shared memory messages are used for accessing distributed shared memory resources.

### Switch Element

In the preferred embodiment, the bidirectional links 15 that connect a given switch element 14 to the neighboring four switch elements and to the node associated therewith include a logical grouping of five NOC links: a west NoC link, a north NoC link, an east NOC link, a south NOC link, and a node NOC link. Each NOC link includes a pair of Data NoCs (labeled Data 1 NoC and Data 2 NoC) each including a 5-tuple incoming bus and a 5-tuple outgoing bus as well as a Control NOC including a 5-tuple control bus. Each bus of the 5-tuple communicates five signals: Data, SOM, EOM, Valid and Ready. The Data signal is 64 bits wide and carries 64-bit words that are transmitted over the respective bus. The Start Of Message (SOM) signal marks the first word of a message. The End Of Message (EOM) signal marks the last word of a message. The Valid signal is transmitted by the transmit side of the respective bus to indicate that valid data is being transmitted on the respective bus. The Ready signal is transmitted from the receive side of the respective bus to indicate that the receiver is ready to receive data. For the incoming buses, the Data, SOM, EOM and Valid signals are received (or input) on the respective data buses while the Ready signal is transmitted (or output) on the respective data buses. For the outgoing buses, the Data, SOM, EOM and Valid signals are transmitted (or output) on the respective data buses while the Ready signal is received (or input) on the respective data buses. Each direction has a separate control bus. For the control bus of incoming data, the Data, SOM, EOM and Valid signals are received (or input) on the incoming control bus while the Ready signal is transmitted (or output) on the incoming control bus. For the control bus of outgoing data, the Data, SOM, EOM and Valid signals are transmitted (or output) on the outgoing control bus while the Ready signal is received (or input) on the outgoing control bus. The Valid signal enables the transmit side of the respective outgoing data buses to delay a data transfer preferably by pulling-down (inactivating) the Valid signal. The Ready signal enables the receive side of the respective incoming data buses to delay a data transfer preferably by pulling down (inactivating) the Ready signal. Such delay is typically used to alleviate backpressure.

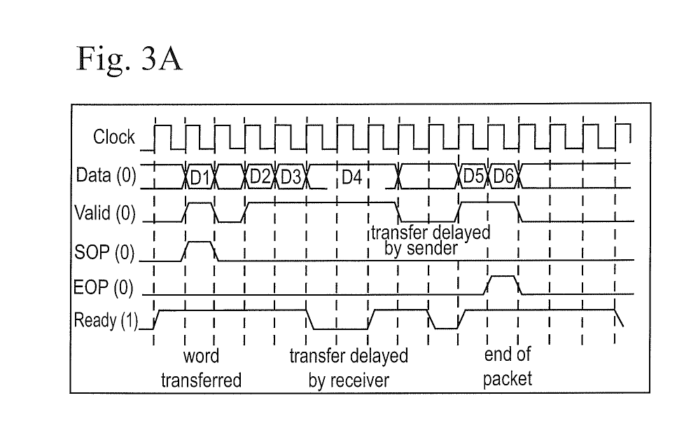

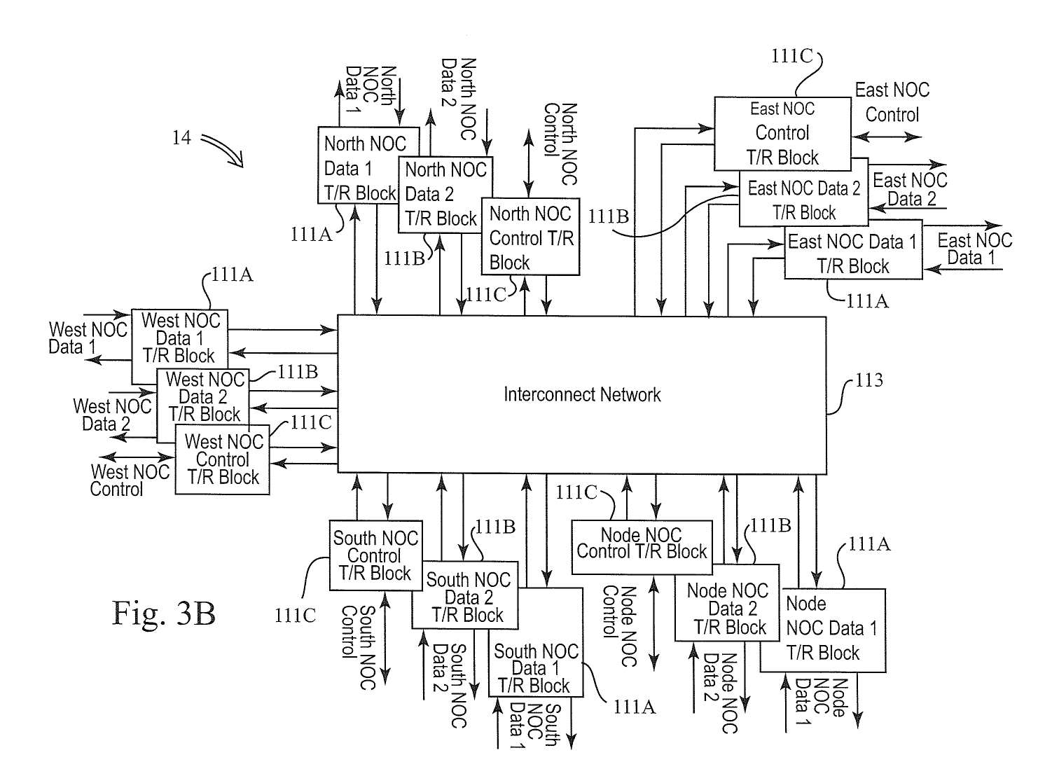

An example of the signals carried on each one of the bus 5-tuples of a respective NoC link is illustrated in FIG. 3A. Note that the clock signal that dictates the transmissions between words carried by the data signal of each respective bus is common to all of the buses and is provided independently preferably by the clock signal generator block 19 of FIG. 1.

The switch elements 14 are also adapted to support wormhole switching of the messages carried over the NoC. In wormhole switching, the message is broken into small pieces, for example 64-bit data words, with a NoC header that holds information about the message's route followed by a body containing the actual pay load of data. The NoC header is used to assign to the message an outgoing NOC that corresponds to the designated route encoded by the NoC header. Once a message starts being transmitted on a given outgoing NoC, the buses of the outgoing NoC are permanently assigned to that message for the whole message's length. The EOM signal triggers bookkeeping operations that release the buses of the outgoing NoC at the message's end. Wormhole switching advantageously reduces buffering requirements by buffering data-words (not entire messages). It also simplifies traffic management as the transmission of a message from an input NoC to an output NoC is never affected by the state of the other output NoCs.

Moreover, the NoC headers preferably carry static routing information (e.g., 24 hops per message header) as described herein. Such static routing eliminates the need for routing tables stored in the switch elements and also enables a higher degree of configurability, since there is no HW constraint on the maximum number of routes supported through each switch element.

In the preferred embodiment, the switch element 14 employs an architecture shown in FIG. 3B, which includes three transmit/receive blocks 111A, 111B, 111C for each one of the five NoC links (West, North, East, South. Node). Each transmit/receive block 111A interfaces to a corresponding Data 1 NoC. Each transmit/receive block 111B interfaces to a corresponding Data 2 NoC. Each transmit/receive block 111C interfaces to a corresponding Control NoC. In this exemplary configuration, the transmit/receive block 111C sends and receives control packets on the Control NoC. These groups of transmit/receive blocks 111A, 111B, 111C are interconnected to one another by a static wireline interconnect network 113.

Each respective transmit/receive block supports wormhole switching of an incoming NoC message to an assigned output NoC link as dictated by the routing information contained in the NoC header of the incoming message. The words of the incoming NoC message are buffered if the receiver's backpressure signal (Ready) is inactive. Else, the incoming words are sent directly to the destination link. The Node NoC links support backpressure as well.

In the preferred embodiment, data messages as described above are carried only on Data NoCs. Flow control messages are carried only on Control NoCs. Interrupt messages are carried on either Data NoCs or Control NoCs. Configuration messages are carried on either Data NoCs or Control NoCs. Shared Resource messages and Shared Memory messages are carried only on Data NoCs. Other configurations can be used.

### NoC-Node Interface

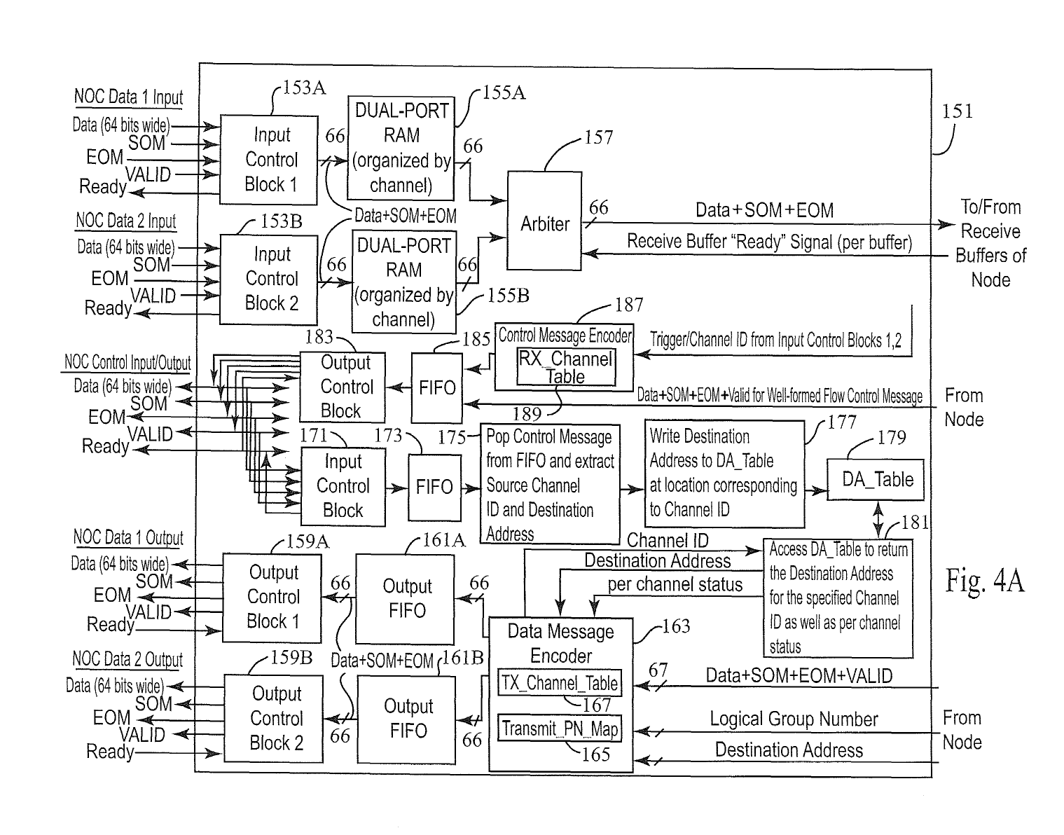

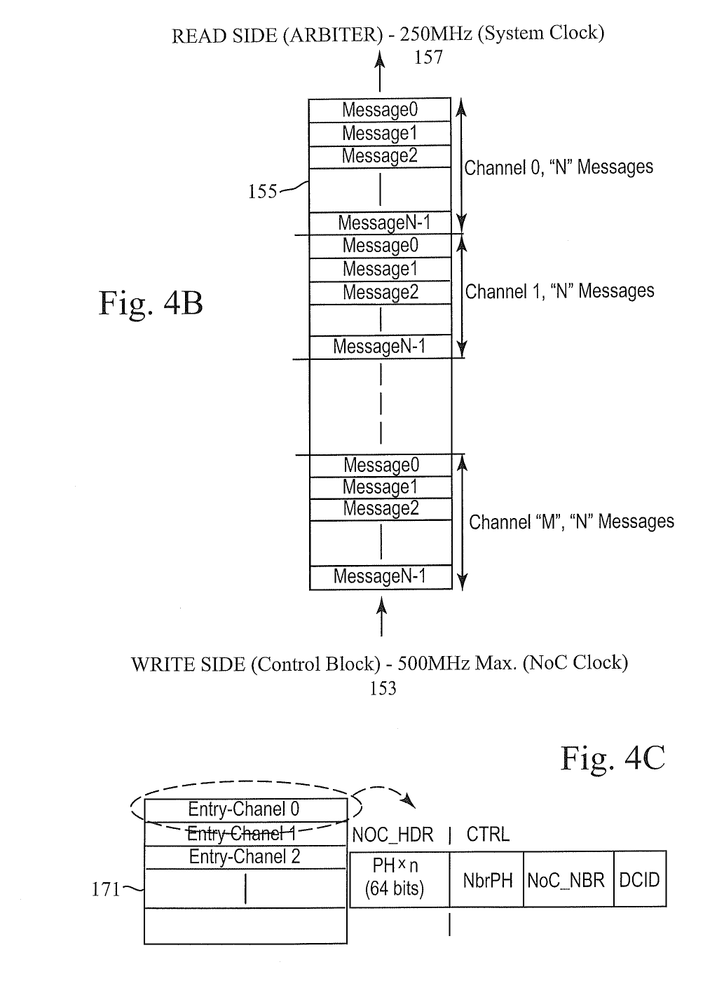

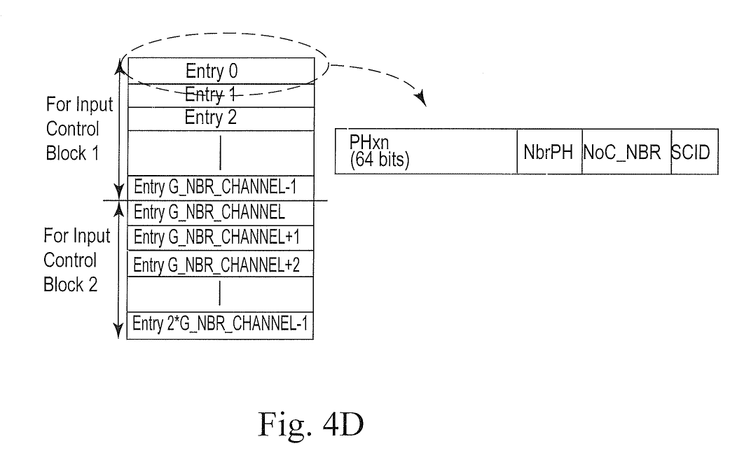

The nodes of the SOC 10 preferably include a NoC-Node interface 151 as shown in FIG. 4A, which provides an interface to the links (e.g., Node Data 1 NoC, Node Data 2 NoC, and Node NoC Control bus) of the NoC. The interface 151 is generally organized as an incoming side (input control blocks 153A, 153B, RAMs 155A, 155B and Arbiter 157), an outgoing side (output control blocks 159A, 159B, Output FIFOs 161A, 161B and Data Message Encoder 163), and a control side (input control block 171, Input FIFO 173, logic blocks 175-181, output control block 183, output FIFO 185 and control message encoder 187).

The incoming side of the NoC-node interface 151 has two input control blocks 153A, 153B that handle the interface protocol of the incoming buses of the respective Node NoC Data link to receive the 64-bit data words and SOM and EOM signals of an incoming message carried on the respective incoming Node NoC data link. The received 64-bit data words and SOM and EOM signals are output over a 66-bit data path to respective dual-port RAMs 155A, 155B, which act as rate decouplers between the clock signal of the NoC, for example, at a maximum of 500 MHz, and a system clock operating at a different (preferably lower) frequency, for example at 250 MHz. The memory space of the respective RAMs 155A, 155B is subdivided into sections that uniquely correspond to channels, where each section holds messages that pertain to the corresponding channel. In the preferred embodiment, each channel is implemented as a FIFO-type buffer (with a corresponding write and read pointer) as illustrated in FIG. 4B. In the preferred embodiment, the input control blocks 153A, 153B extract and decode the Destination Channel ID field from the CH_INFO word of the received message as described above. The extracted Destination Channel ID is used to generate the write pointer of the corresponding channel space in RAM 155A/B. The incoming words (64-bit data and SOM/EOM signals for the message) are then stored in the appropriate RAM 155A/B with the first word (qualified by SOM) written to the address pointed by the calculated write pointer. The write pointer is then updated to point to the next location in RAM 155A/B for the corresponding channel.

The input control blocks 153A, 153B also preferably cooperate with the control message encoder 187 of the control side to output flow-control messages over the Control NoC to the source node of the incoming message as described above. Such flow-control messages can indicate the number of message buffers available in RAM 155A or 155B for a given communication channel. In the preferred embodiment, such flow control messages are communicated at start-up and when channel memory space in the RAM 155A or 155B is made available. Once a message is popped from a channel space in RAM 155A or 155B by the Arbiter 157, the Control Message Encoder 187 will be notified by the Arbiter 157 to output a flow control message to the sender. When doing so, the Arbiter 157 also signals the channel space number in RAM 155A or 155B where the message is popped. This channel number is used by the Control Message Encoder 187 to index into the Receive Channel Table 189 (described below) to get the NoC header which specifies the route to the message sender. In addition, the Receive Channel Table 189 also stores the “source channel ID” field for that sender. Using the NoC header and the “source channel ID”, the flow control message can be formulated as in FIG. 2C. The “source channel ID” is placed in the CH_INFO word.

An arbiter 157 interfaces to the two RAMs 155A, 155B to readout the messages stored in the RAMs for output to Receive FIFO buffers maintained by the node in accordance with a servicing scheme. The arbiter 157 reads out message data on message boundaries only. One or more channels of the respective RAMS are preferably assigned to a given Receive FIFO buffer. Such assignments are preferably maintained in a table realized by a register or other suitable data storage structure. A Receive FIFO buffer “Ready” signal for each Receive FIFO buffer is provided to the arbiter 157 for use in the serving scheme. In the preferred embodiment, the servicing scheme carried out by the arbiter 157 employs two levels of arbitration. The first level of arbitration selects one of the two RAMs 155A, 155B. Two mechanisms can be employed to carry out this first level. The first mechanism employs a strict priority scheme to select between the two RAMs 155A, 155B. The second mechanism services the two RAMS on first come first served basis with round robin selection to resolve conflicts. Selection between the two mechanisms can be configured dynamically at start-up (for example, by writing to a configuration register that is used for this purpose) or through other means. The second level of arbitration is among all channels of the respective RAM selected in the first level. This second level preferably services these channels on first come first served basis with round robin selection to resolve conflicts. Each channel of the respective RAM selected in the first level whose corresponding Receive FIFO Buffer “Ready” signal is active is considered in this selection process. The Arbiter 157 also receives per logical group backpressure signals from the Node. Logical groups that cannot receive data are inhibited from participating in the arbitration.

The outgoing side of the NoC-node interface 151 has two output control blocks 159A, 159B that handle the interface protocol of the outgoing buses of the respective Node Data NoC to transmit 64-bit data words and SOM and EOM signals as part of outgoing messages carried on the respective outgoing Node Data NoC link. The transmitted 64-bit data words and SOM and EOM signals are input over a 66-bit data path from respective dual-port output FIFO buffers 161A, 161B, which act as rate decouplers between the clock signal of the NoC and the system clock in the same manner as the RAMS 155A, 155B of the incoming side. A data message encoder 163 formats data chunks (e.g., 64-bit words as well as SOM, EOM and Valid signals) received from the node into NoC messages, and outputs such NoC messages to one of the Output FIFO buffers 161A, 161B.

In the preferred embodiment, the encoder 163 receives a signal from the node that indicates the logical group number pertaining to a given chunk. The encoder 163 maintains a table 165 called Transmit_PN_MAP that is used to translate the logical group number of the chunk as dictated by the received logical group number signal to a corresponding channel ID. The control side of the interface 151 maintains a table 179 called DA_Table that maps Channel IDs to Destination Addresses and Channel Status data. In the preferred embodiment, the DA_Table 179 is logically organized into sections that uniquely correspond to channels, where each section holds the Destination Addresses (i.e., available buffer addresses) and Channel Status data for the corresponding channel. In the preferred embodiment, each section is implemented as a FIFO-type buffer (with a corresponding write and read pointer). After obtaining the Channel ID for the chunk from the Transmit_PN_MAP, a request is made to logic 181 to access the DA_Table 179 to retrieve the Destination Address and Channel Status corresponding to the obtained Channel ID. The retrieved Destination Address and Channel Status are passed to the encoder 163 for use in formulating the CH_INFO word of the message. The Destination Address used in formulating the CH_INFO word of the message can also be provided to the encoder 163 by the node itself via a destination address bus signal as shown. The PIT is regarded as data by the block 151.

The encoder 163 maintains a Transmit Channel Table 167, also referred to as TX_CHANNEL_TBL, which includes entries corresponding to the transmit channels for the node. As shown in FIG. 4C, each entry of the Transmit Channel Table 167 stores the following information for the corresponding “transmit” channel:
a number of 64-bit NOC header words (PH1, PH2, . . . PHn); each PH header word is 64 bits;
a NbrPH field; this field specifies how many PH words constitute the NoC Header for that channel; for example, if NbrPH is 1, PH1 will be used only. If NbrPH is 2, PH1 and PH2 constitute the NoC Header and PH1 is the first NoC header word;
a NoC_NBR field; this field specifies the NoC number that the channel corresponds to; and
a DCID field; this field specifies the destination channel ID to form the CH_INFO word. Note that CH_INFO contains a destination ID and a destination address (DA) field. The DA is stored in DA_Table 179.
   The encoder 163 uses the channel ID for the message to identify and retrieve the TX_CHANNEL_TBL entry corresponding thereto. The encoder 163 utilizes the Destination Address retrieved from the DA_Table 167, PIT data provided by the node (if any) as well as the information contained in the retrieved TX_CHANNEL_TBL entry to formulate the message according to the appropriate message format (FIGS. 2B, 2D, 2E1, 2F1, 2G).

The control side of the NoC-node interface 151 includes an input control block 171 that handles the interface protocol of the Node Control NoC link when receiving the 64-bit data words and SOM and EOM signals of incoming flow control signals carried on the Node Control NoC link. The received 64-bit data words and SOM and EOM signals of the received flow control signal are output over a 66-bit data path to a dual-port Input FIFO 173, which acts as a rate decoupler between the clock signal of the NoC and the system clock in the same manner as the RAMS 155A, 155B of the incoming side. Logic block 175 pops a received flow control message from the top of the Input FIFO 173 and extracts the Channel ID and Destination Address from this received flow control message. Logic 177 writes the Destination Address extracted by logic block 175 to the DA_Table 179 at a location corresponding to the Channel ID extracted by logic block 175. In the preferred embodiment, this write operation utilizes the write pointer for the corresponding FIFO of the DA_Table, and then updates the write pointer to point to the next message location in the corresponding FIFO of the DA_Table. When a flow control message is received, once the DA_Table is written, a per channel credit count is incremented in 179. This count is used to backpressure the Node, i.e. when the count is 0, the Node will be backpressured and will be inhibited from sending data to 163. Therefore, this implies that there is a per logical group backpressure signal to the Node from 179.

The control side of the NoC-node interface 151 also has an output control block 183 that handles the interface protocol of the Node Control NoC link when transmitting 64-bit data words and SOM and EOM signals as part of outgoing messages carried on the Node Control NoC link. The transmitted 64-bit data words and SOM and EOM signals are input over a 66-bit data path from a dual-port output FIFO buffer 185, which acts as a rate decoupler between the clock signal of the NoC and the system clock in the same manner as the RAMS 155A, 155B of the incoming side. A control message encoder 187 maintains a Receiver Channel Table 189 (also referred to as RX_CHANNEL_TBL), which includes entries corresponding to the channels received by the input control blocks 153A, 153B of the node. As shown in FIG. 4D, each entry of Receiver Channel Table 189 stores the following information for the corresponding “receive” channel:
“PH” is a 64-bit NoC Header word for routing a flow control message to transmitter node of the channel; and
“SCID” is a 13-bit “Source Channel ID” field corresponding to the channel; it is used to form the CH_INFO word of the flow control message communicated to the transmitter node of the channel.

The encoder 187 receives a trigger signal and Channel ID signal from Input Control Block 153A or 153B. The received Channel ID is used to index into the RX_CHANNEL_TBL 189 to retrieve the entry corresponding thereto. The encoder 183 utilizes the information contained in the retrieved RX_CHANNEL_TBL entry to formulate the message according to the desired flow control message format (FIG. 2C) and outputs such message to the Output FIFO buffer 185. In the preferred embodiment, the FIFO buffer 185 can also receive well-formed flow control signals directly from the node for output over the NoC control bus by the output control block 183.

Processing element

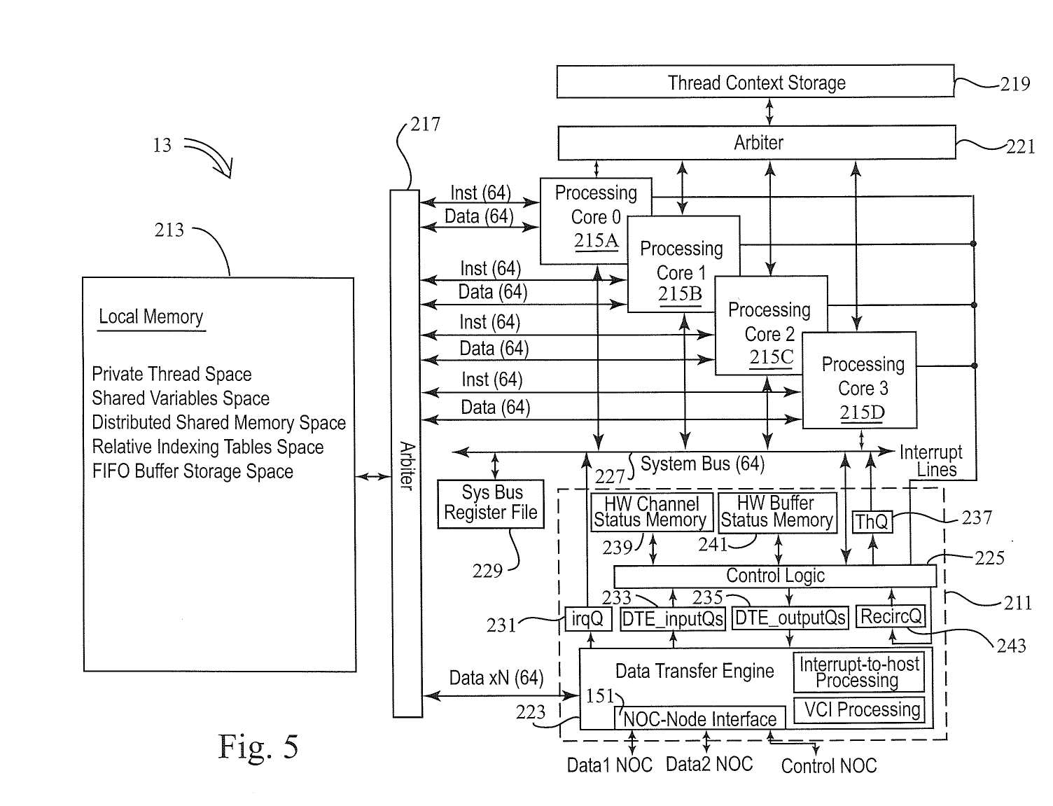

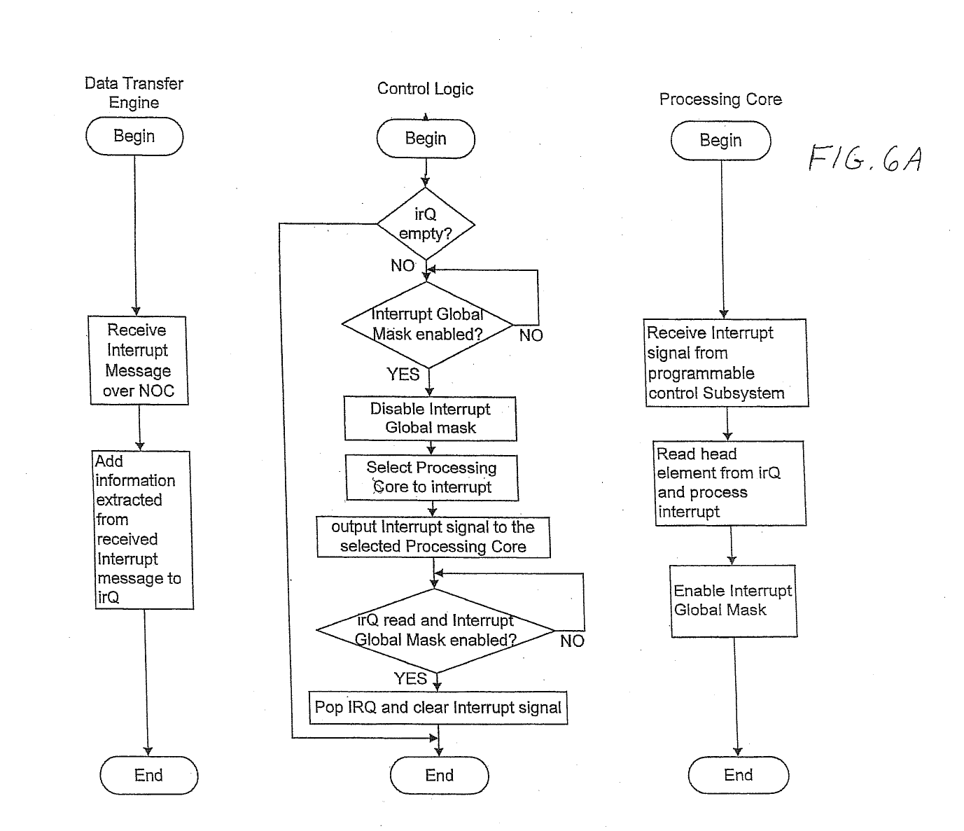

In the preferred embodiment of the present invention, the PEs 13 of the SOC 10 employ an architecture as shown in FIG. 5, which includes a communication unit 211 and a set of processing cores (for example 4 shown as 215A, 215B, 215C, 215D) that both interface to local memory 213. Each processing core 215A-215D includes a RISC-type pipeline of stages (e.g., instruction fetch, decode, execution, access, writeback) and a set of general purpose registers (e.g., a set of 31 32-bit general purpose registers) for processing a sequence of instructions. The instructions along with data utilized in the execution of such instructions are stored in the local memory 213. In the preferred embodiment, the local memory 213 is organized as a single level of system memory (preferably realized by one or more static or dynamic RAM modules) that is accessed via an arbiter 217 as is well known. Each processing core 215A-215D has separate instruction and data signaling pathways to the arbiter 217 for fetching instructions from the local memory 213 and reading data from the local memory 213 and writing data to the local memory 213, respectively. Other memory organizations can be used, such as hierarchical designs that employ one or more levels of cache memory as is well known. The instruction set supported by the processing cores preferably conform to typical RISC instruction set architectures, which include the following:
a single word with the opcode in the same bit position in every instruction (simplifies decoding);
identical general purpose registers (this allows any register to be used in any context); and
support for simple addressing modes, whereby complex addressing is performed via sequences of arithmetic and/or load-store operations.
   An example of such a RISC instruction set architecture is the MIPS R3000 ISA well known in the computing arts.

The processing cores 215A-215D also interface to dedicated memory 219 for storing the context state of the respective processing cores (i.e., the general purpose registers, program counter, and possibly other operating system specific data) to support context switching. In the preferred embodiment, each processing core 215A-215D has its own signaling pathway to an arbiter 221 for reading context data from the dedicated memory 219 and writing context state data from the dedicated memory 219. The dedicated memory 219 is preferably realized by a 4 KB random-access module that supports thirty-two 128-byte context states.

The communication unit 211 includes a data transfer engine 223 that employs the Node-NoC interface 151 of FIG. 4A for interfacing to the Node data and control bus links of the NoC in the preferred embodiment of the invention. The data transfer engine 223 performs direct-memory-access-like data transfer operations between the bus links of the NoC and the local memory 213 as well as loop-back data transfers with respect to the local memory 213 as described below in more detail.

The communication unit 211 also includes control logic 225 that interfaces to the processing cores 215A-215D via a shared system bus 227 as shown. The control logic 225 is preferably realized by application-specific circuitry. However, it is also contemplated that programmable controllers, such as programmable microcontroller and the like can also be used. A system-bus register file 229 is accessible from the shared system bus 227. The shared system bus 227 is a memory-mapped-input-output interface that allows for data exchange between the processing cores 215A-215D and the control logic 225, data exchange between the processing cores themselves as well as communication of control commands between the processing cores 215A-215D and the control logic 225. The shared system bus 227 includes data lines and address lines. The address lines are used to identify a transaction type (e.g., a particular control command or a query of a particular register of a system bus register file). The data lines are used to exchange data for the given transaction type. The system-bus register file 229 is assigned a segmented address range on the shared system bus 227 to allow the processing cores 215A-215D and the control logic 225 access to registers stored therein. The registers can be used for a variety of purposes, such as exchanging information between the processing cores 215A-215D and the control logic 225, exchanging information between the processing cores themselves, and querying and/or updating the state of execution status flags and/or configuration settings maintained therein.

In the preferred embodiment, the system-bus register file 229 includes the following registers:

Processing Core Control and Status register(s) storing control and status information for the processing cores 215A-215D; such information can include execution state of the processing cores 215A-215D (e.g., idle, executing a thread, ISR, thread ID of thread currently being executed); it can also provide for software controlled reset of the processing cores 215A-215D;

Interrupt Queue control and status register(s) storing information for controlling interrupt processing for the for the processing cores 215A-215D; such information can enable or disable interrupts for all processing cores (global), enable or disable interrupts for a calling processing core, or enable or disable interrupts for particular processing cores;

Interrupt-to-Host control register(s) storing information for controlling Interrupt-to-host messaging processing for the processing cores 215A-215D; such information can enable or disable interrupt-to-host messages for all processing cores (global), enable or disable interrupt-to-host messages for the calling processing core, enable or disable interrupt-to-host messages for particular processing cores; enable or disable interrupt-to-host messages for particular events; it can also include information to be carried in an Interrupt-to-host message;

Thread status and control register(s) storing state information for the threads executed by the processing cores 215A-215D; such state information preferably represents any one of the following states for a given thread: sleeping, awake but waiting to be executed, and awake and running; it also stores information that identifies the processing core that is running the given thread;

ReadyThread Queue control and status register storing information for configuring mapping of ReadyThread Queues to the processing cores 215A-215D and other information used for thread management as described below in detail; and

Timer control and status register(s) storing information for configuring multiple clock timers (including configuring frequency and roll-over time for the clock timers) as well as multiple wake timers (which are triggered by interrupts, thread events, etc. with configurable time expiration and mode (one-shot or periodic)).

The communication unit 211 also maintains a set of queues that allow for internal communication between the data transfer engine 223 and the processing cores 215A-215D, between the data transfer engine 223 and control logic 225, and between the control logic 225 and the processing cores 215A-215D. In the preferred embodiment, these queues include the following:

Interrupt Queue 231 (labeled irqQ), which is a queue that is updated by the data transfer engine 223 and monitored by the processing cores 215A-215B to provide for communication of interrupt signals to the processing cores 215A-215B;

Network Input Queue(s) 233 (labeled DTE-inputQs), which is one or more queues that is(are) updated by the data transfer engine 223 and monitored by the control logic 225 to provide for communication of notifications and commands from the data transfer engine 223 to the control logic 225; in the preferred embodiment, there are three network input queues (inQ0, inQ1, inQ2) that are uniquely associated with the three buses of the NoC (NoC Databus 1, NoC Databus 2, NoC Control bus); in the preferred embodiment, the buses of the NoC are assigned identifiers in order to clearly identify each bus of the NoC connected to the data transfer engine 223;

Data Output Queue(s) 235 (labeled DTE_outputQs), which is one or more queues that are updated by the control logic 225 and monitored by the data transfer engine 223 to provide for communication of commands from the control logic 225 to the data transfer engine 223; such commands initiate the transmission of outgoing data messages and flow control messages over the NoC; in the preferred embodiment, there are three data output queues (dataOutQ1, dataOutQ2, dataOutQ3) that are uniquely associated with the NoC Data 1 bus, NoC Data 2 bus, NoC control bus, respectively; commands are maintained in the respective queue and processed by the data transfer engine 223 to transmit an outgoing message over the corresponding NoC bus;

ReadyThread Queues 237 (labeled thQ) that are updated by the control logic 225 and monitored by the processing cores 215A-215D for managing the threads executing on the processing cores 215A-215D as described below in more detail; and

a Recirculation Queue 243 239 (labeled RecircQ) as described below.

The PE 13 supports a configurable number of unidirectional communication channels as describe herein. A communication channel is a logical unidirectional link between one sender and one receiver. Each channel has one single route. Each channel is associated with exactly one thread on each end of the link. To support such communication channels, the communications unit 211 preferably maintains channel status memory 239 and buffer status memory 241. The channel status memory 239 stores status information for the communication channels used by the processor element in communicating messages over the NoC as described herein. The buffer status memory 241 stored status information for the buffers that store the data contained in incoming messages and outgoing messages communicated over the NoC as described herein. The channel status memory 239 is initialized to default values by the management software during reset. It contains state variables for each communication channel, which are updated by the communication unit while processing the communication events. The buffer status memory 241 is used to create fifo-queues for each channel. For a transmit channel, the entries in these fifos represent messages to be transmitted (buffer−address+length), or they represent a received credit (buffer address for the remote received). For a receive channel, the entries in these fifos represent messages that have been received from the NoC (buffer−address+length), or they represent transmitted credits (buffer−address+length). The transmitted credit info is used only for error checking when a message is received from the NoC: the buffer address in the message must match the address of a previously transmitted credit; furthermore, the length of a received message must be smaller or equal than the length of the previous credit. The buffer status memory contains the actual fifo entries as described above. The channel status memory 239 contains, for each channel, control information for each channel-fifo, like base-address in the channel status memory, read pointer, write pointer and check pointer.

The local memory 213 preferably stores communication channel tables that define the state of a respective channel (more precisely, a single transmit or receive channel) with the following information:

```
integer Count; /* 8 bits
        * For TX Channel: # of free places in the channel
        * For RX Channel, # of received messages
          */
integer CountTh; /* 8 bits
        * Channel is ready if Count >= CountTh
        * Normally, CountTh is set to 1
          */
integer MuxIndex; /* 8 bits
          * Index of channel in mux channel construct
          */
integer MuxChanID; /* 9 bits
          * The parent mux-channel, or 0
          */
boolean ThWaiting; /* 1 bit
          * Set if a thread is waiting on this channel
          * Only when ThWaiting is set, then a wakeup-event
        into a ThreadQ can be generated
          */
boolean MuxWaiting; /* 1 bit
          * Set if a muxh-channel is waiting on this channel
          * Only when MuxWaiting is set, then a wakeup-event
        into a recirculation queue can be generated
          */
boolean RXCheckEnabled; /* 1 bit
          * If set, the addr+len in incoming msg is checked
          */
boolean TimerRunning; /* 1 bit
          * If set, the timer is active and can cause timeout
          */
boolean ForceRecirc; /* 1 bit
          * When set, forces an incoming message to be
              immediately
          * written to recirculation queue, together with MuxIndex
          * This is used by RxAny.
          * Note that the message length is not accessible using
          * this construct (which is OK for most scenarios)
          */
boolean TwinBuffers; /* 1 bit
          * When set, the channel will transmit only twin buffers,
          * each send will have two addresses and two lengths
          */
boolean TxNotRx; /* NEW: Sept 8
          * 1 bit
        * true for RX channels, false for TX channels
        */
integer ChanSize; /* 8 bits
          * The number of buffers allocated to the channel.
          * During initialization of a read-channel, it is 0
          * After an init-message is received on a read channel,
          * ChanSize will be set to its correct value.
          * For a write-channel, ChanSize will be set to its
          * correct value before an init message is sent
          * For twin-channels, ChanSize represent the number of
          * twin-buffers (i.e. the actual amount of buffers allocated
          * in the BufState memory is 2*ChanSize
          */
integer WrPtr; /* 8 bits
          * For write-channels: WrPtr points to the next location in
          * BufStateMem where a write-message can be written
          */
integer RdPtr; /* 8 bits
          */
integer ChkPtr; /* 8 bits
          */
uint32_t WakeupTime; /* 24 bits
          */
integer BufferState; /* 11 bits
          * Index in the BufferStatusMemory
          */
integer ThreadNr; /* 8 bits
          * Thread number and SMP info
          */
```

The following fields are initialized by the system and used by the

```
communication unit:
integer NoCID; /* 2 bits
          */
integer RemoteChanID; /* 9 bits
          * The channelID in the remote PE
          */
integer NoCHeaderSize; /* 4 bits
          * Support max of 16 NoC header words for sending data
          */
integer NoCHeaderAddr; /* 18 bits
        * This is the address in the local data memory
        * where the NoC header for data msgs is stored
          */
```

The NoCHeaders of messages to be transmitted are stored in the local memory 213 of the PE 13. All other channel status information is stored in the channel status memory 239. This allows an optimal implementation and performance: when the communication controller updates the state of a cannel it accesses its local memories (i.e., Channel Status Memory and/or Buffer Status Memory), and does not consume bandwidth of the local memory 213. Furthermore, when messages are transmitted, the local memory 213 needs to be accessed anyway by the data transfer engine 223 to read the message. Having the NoC-header in the local memory is efficient, since it requires one (or more, depending on the size of the NoCHeader) accesses to the local memory 213 to retrieve the NoC header.

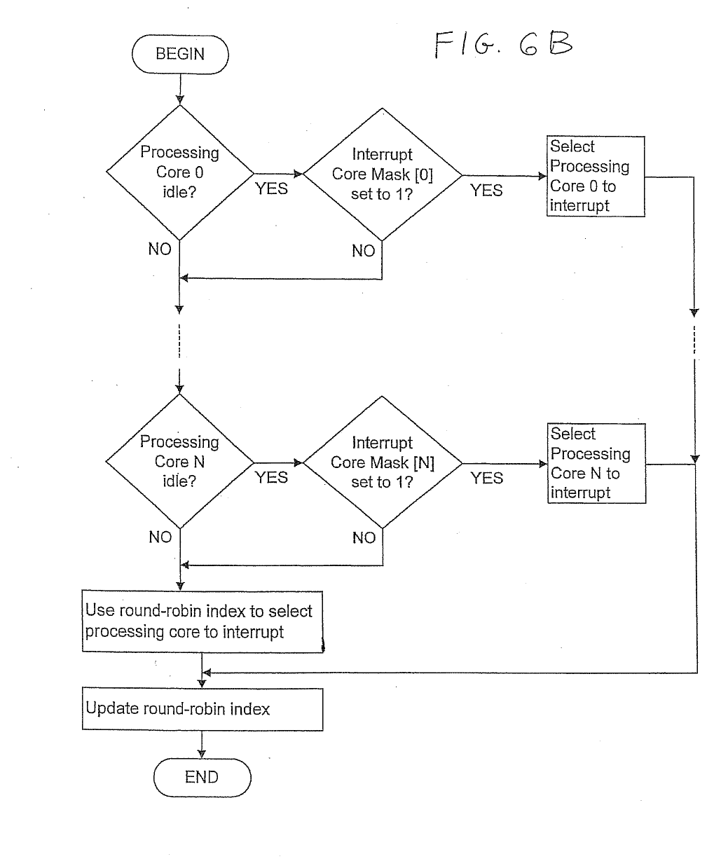

In the preferred embodiment as illustrated in FIG. 6A, the data transfer engine 223, control logic 225 and processor cores 215A-215D cooperate to receive and process interrupt messages communicated over the NoC to the PE 13. The data transfer engine 223 receives an Interrupt Message over the NoC and pushes information extracted from the received Interrupt message (e.g., the Interrupt ID from the message along with an optional Interrupt word which used to identify the received interrupt on an application-specific basis) onto the bottom of the Interrupt Queue 231. The control logic 225 periodically executes an interrupt servicing process that checks whether the Interrupt Queue 231 is empty via the system bus 227. If non-empty, the control logic 224 checks whether an Interrupt Global Mask stored in the Sys-Bus Register file is enabled. In the enabled state, this status flag provides an indication that no interrupt signal is currently being processed by one of the processing cores. In the disabled state, this status flag provides an indication that an interrupt signal in currently being processed by one of the processing cores. In the event that the Interrupt Global Mask is enabled, the control logic 225 disables the Interrupt Global Mask, selects a processing core to interrupt and then outputs an interrupt signal to the selected processing core over the appropriate interrupt line coupled therebetween. Upon receipt of the interrupt signal, the processing core reads the Interrupt ID (and possibly the optional Interrupt word) from the head element of the Interrupt Queue 231 via the system bus 227. This read operation acts as an acknowledgement of the interrupt signal and enables the Interrupt Global mask. The control logic 225 waits for the head element to be read and the Interrupt Global mask to be disabled. When these two conditions are satisfied, the control logic 225 pops the head element from the Interrupt Queue 231 and clears the interrupt signal from the interrupt line and thus allows for interrupt processing for the next element in the Interrupt Queue 231.

Note that use of the Interrupt Global Mask as described above prevents a race condition where more than one processing core is interrupted at the same time. More particularly, this race condition is avoided by disabling the Interrupt Global Mask, which operates to delay processing any pending interrupt in the Interrupt Queue before generating an appropriate interrupt signal.

In order to optimize the bandwidth consumption of the processing cores, the state of the processing cores can be used to select the processing core to be interrupted as shown in FIG. 6B. If no processing core is idle, the processing core to be interrupted is selected on a round-robin basis, to ensure avoiding unbalanced starvation of the running threads. If at least one processing core is idle, the first idle processing core is selected. There is no need to perform any selection over the idle processing cores, because any incoming ready-thread could be as well resumed on any of the remaining idle processing cores. Interrupting an idle processing core could possibly result in delaying the next thread to be resumed, in the case the other processing cores never switch thread during the interrupt handling. After the thread has been resumed with the delay due to the interrupt, if another interrupt arrives and all processing cores are busy, there could be the risk to interrupt the same thread that has just been delayed, functionally equivalent to interrupting the same thread twice in a row. To avoid this unbalanced case, the round-robin index is updated to point to the next processing core.

The selection of the processing core to interrupt can also be configurable and set by corresponding bits in an Interrupt Core Mask that is part of the Sys-Bus Register file 229. Such configurability provides fine-grain control over the default interrupt handling process, for instance to configure the interrupt handling according to the requirements of a specific logical processing core layout.

In the preferred embodiment, the data transfer engine 223, control logic 225 and processor cores 215A-215D cooperate to generate and transmit interrupt messages over the NoC from the PE 13. As described above, the SOC 10 can include a control processor 22 that is tasked to manage, control and/or monitor other nodes of the system. In such a system, interrupt messages to this control processor 22 (referred to herein as “interrupt-to-host” messages) can be used to provide event notification for such management, control and/or monitoring tasks. In the preferred embodiment, the software threads that execute on the processing cores 215A-215D can generate and send interrupt-to-host messages by writing to predefined registers of the register file 229 (e.g., the Hostinterrupt.Info[.] register). Each write operation to any one of these predefined register triggers the generation of an interrupt-to-host message to the control processor 22. In the preferred embodiment, the interrupt-to-host message employs the format described herein with respect to FIG. 2D. The generation of interrupt-to-host messages on the PE 13 can be configured on an event-by-event basis by updating a dedicated interrupt mask stored in the register file 229, for example, setting a bit of the mask corresponding to the predefined register file for the event to “1” to enable interrupt-to-host messages for the event and setting this bit to “0” to disable interrupt-to-host messages for the event.

In the preferred embodiment, the data transfer engine 223, control logic 225 and processor cores 215A-215D cooperate to support communication of configuration messages over the NoC to the PE 13. Configuration Messages enable configuration of the PE 13 as well as the configuration of software functions running on the RISC processors of the PE 13. For both situations the writing and reading of configuration is administered the same. This is accomplished using a message format described herein with respect to FIGS. 2E1 and 2E2. In this case, the Write or Read command words can be VCI transactions that are processed by the VCI processing function of the data transfer engine 223. Hardware write or read transactions are executed and an acknowledgment is optionally returned when specified in the Command word. Firmware configuration is written and read commands that operate on soft registers mapped inside the local memory 213.

In the preferred embodiment, the data transfer engine 223, control logic 225 and processor cores 215A-215D cooperate to receive and process shared-resource communication messages transmitted over the NoC to the PE 13. The unidirectional communication channels supported by the data transfer engine 223 and control logic 225 can be used as part of such shared-resource communication messages. As described above, shared-resource communication messages allows for communication between a processing element and another node for accessing shared resources of the other node and/or for “chained communication” that involves inserting one or more shared-resources (e.g., coprocessors) in the messaging path between two nodes. The shared resources can involve communication primitives as described below in more detail. The shared-resource communication messages can be communicated as part of a flow control data transfer scheme and/or an unchecked data transfer scheme as described herein.

Incoming shared-resource communication messages are stored in FIFO buffers maintained in the local memory 213. For each incoming shared-resource communication message, the following information is stored in the FIFO buffer corresponding to the input channel ID designated by the message:
the Encapsulated Shared Resource Message;
the Command portion, which can define a predetermined communication primitive as described below;
the Data portion; and
size of the Data portion.

A reply to a shared-resource communication message can be triggered by the processing element 13 (preferably by the shared-resource thread executing on one of the processing cores 215A-215D). In this case, the Encapsulated Shared Resource Message header previously stored in the FIFO buffer is prepended to the outgoing reply message.

In the preferred embodiment, an incoming shared-resource communication message is received and buffered by the data transfer engine 223 of the PE 13. The data transfer engine 223 then issues a message to the control logic 225, which when processed by the control logic 225 awakes a corresponding thread (the shared-resource thread) for execution on one of the processing cores of the processing element by adding the thread ID for the shared-resource thread to the bottom of the Ready Thread queue 237. When awake, the shared-resource thread can query the state of the corresponding FIFO buffer via accessing corresponding register of the Sys-Bus register file 229. It is possible for the shared-resource thread to be awakened only once for processing shared-resource communication messages, for example in servicing a burst of such messages. The shared-resource thread can access the sys-bus register file 229 (i.e., GetNextBuffer register) to obtain a pointer for the next buffer to process (this points to the command and data sections of the buffered shared-resource communication message). In this manner, the encapsulated header of the shared-resource communication message is not directly exposed to the shared-resource thread. The shared-resource thread then utilizes this pointer to access the command portion and data portion (if any) of the buffered shared-resource communication message. If necessary, the shared-resource thread can process the command portion to carry out the command primitive specified therein. The operations that carry out the command primitive can utilize data stored in the data portion of the buffered shared-resource communication message.

In the preferred embodiment, a reply to a particular shared-resource communication message is triggered by the shared resource thread by a two-step write and read operation to a register of the Sys-Bus register file 229 that corresponds to the ID of FIFO buffer corresponding to the particular shared-resource communication message (and possibly the NoC ID for communicating the reply). The write operation writes to this register the following: a pointer to the data of the reply as stored in the corresponding FIFO buffer, and the size of the data of the reply. The read operation reads from this register a success or no-success state in adding the reply data to a data output queue. More specifically, in response to the write operation, the control logic 225 attempts to add the reply data pointed to by the write operation to a data output queue (one of dataOut1 and dataOut 2 corresponding to the NoC ID of the request). If there is no contention in adding the reply data to the data output queue and the transfer into the data output queue is successful, a success state is passed back in the read operation. If there is contention in adding the reply data to the data output queue and the transfer into the data output queue is not successful, a no-success state is passed back in the read operation. In the no-success state is passed back in the read operation, the shared-resource thread will repeat the two step operation (possibly many times) until successful. Note that the control logic 225 adds the buffered encapsulated header of the particular shared-resource communication message to the reply data of the reply when adding the reply data to the data output queue.

In the preferred embodiment, the data transfer engine 223, control logic 225 and processor cores 215A-215D cooperate to transmit and receive shared memory access messages over the NoC. It is expected that shared memory access messages will be used to communicate to passive system nodes that are not able to send command messages to the other system nodes. For write operations, the shared memory access message is similar to other data transfer messages and supports posted writes (without ack) and acknowledged writes. For read operations, the shared memory access message contains a header that defines the return path through the NoC for the read data. Note that the return path can lead to a node different from the node that sent the shared memory access message. As described above, a shared memory access message provides access to distributed shared memory of the system, which includes a large system-level memory (accessed via memory access controller node 16) in addition to the local memory 13 maintained by the processing elements of the system.

It is also contemplated that the local memory 13 maintained by the processing elements the system can include parts of one or more tables that are partitioned and distributed across the local memories of the processing elements of the system. In the preferred embodiment, the partitioning and distribution of the table(s) across the local memories of the processing elements of the system is done transparently by the system as viewed by the programmer. In this configuration, the processing elements employ an addressing scheme that translates a Read/Write/Counter-Increment address and determines an appropriate NoC routing header so that the corresponding request arrives at a particular destination processing element, which holds the relevant part of the table in its local memory. It is also contemplated that counter-increment operations can be supported by the addressing scheme.

### Multi-Thread Support

In the preferred embodiment, the processing cores 215A-215D and supporting components of the PE 13 are adapted to process multiple execution threads. An execution thread (or thread) is a mechanism for a computer program to fork (or split) itself into two or more simultaneously (or pseudo-simultaneously) running tasks. Typically, an execution thread is contained inside a process and different threads in the same process share some resources while different processes do not.

In order to support multiple execution threads, the processing cores 215A-215D interface to a dedicated memory module 219 for storing the thread context state of the respective processing cores (i.e., the general purpose registers, program counter, and possibly other operating system specific data) to support context switching of threads. In the preferred embodiment shown, each processing cores has its own signaling pathway to an arbiter 221 for reading and writing state data from/to the dedicated memory module 219. The dedicated memory module is preferably realized by a 4 KB random-access module that supports thirty-two 128-byte thread context states.

The threads executed by the processing cores are managed by ReadyThread Queue(s) 237 maintained by the communication unit 211 and the thread control interface maintained in the sys-bus register file 229. More specifically, a thread employs the thread control Interface to notify the control logic 225 that it is switching into a sleep state waiting to be awakened by a given input-output event (e.g., receipt of message, sending of message, internal interrupt event or timer event). The control logic 225 monitors the input-output events. When an input-output event corresponding to a sleeping thread is detected, the control logic adds the thread ID for the sleeping thread to the bottom of one of the ReadyThread Queues 237.

Note that it is possible that the input-output event that triggers the awakening of the thread can occur before the thread switched into the sleep state. In this case, the control logic 225 can add the thread ID for the sleeping thread to the bottom of a ReadyThread Queue 237. Note that any attempt to awaken a thread that is already awake is preferably silently ignored. Other sources can trigger the adding of a thread ID to the bottom of the ReadyThread Queue 237. For example, the control logic 225 itself can possibly do so in response to a particular input-output event.

When a thread switches from an awaken state to a sleep state, a thread context switch is carried out, which involves the following operations:
the processing core that is executing the thread writes the context state for the thread to the dedicated memory module 219 over the interface therebetween;
in the event that the thread context switch corresponds to a particular input-output request, the input-output request is serviced (for example, carrying out a control command that is encoded by the input-output request); and
the processing core that is executing the thread transitions to a ready-polling state, which is an execution state where the processing core is not running any thread.

When a processing core is in the ready-polling state, it interacts with the thread control interface of the register file 229 to identify one or more ReadyThread Queues 237 that are mapped to the processing core by the thread control interface and poll the identified ReadyThread Queue(s) 237. A thread ID is popped from the head element of a polled ReadyThread Queue 237, and the processing core resumes execution of the thread popped from the polled ReadyThread Queue 237 by restoring the context state of the thread from the dedicated memory 219, if stored therein. In this manner, the thread resumes execution of the thread at the program counter stored as part of the thread context state.

Importantly, the mapping of processing cores to ReadyThread Queues 237 as provided by the thread control Interface of the register file 229 can be made configurable by updating predefined registers of the register file 229. Such configurability allows for flexible assignment of threads to the processing cores of the processing element thereby defining logical symmetric multi-processing (SMP) cores within the same processing element as well as assigning priorities amongst threads.

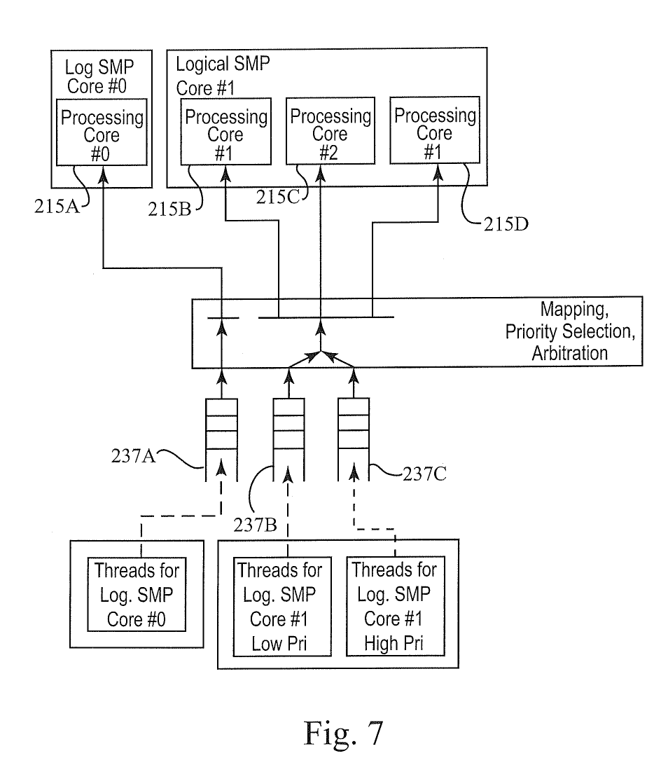

A Logical SMP Core is obtained by assigning one or more processing cores of the processing element to a given subset of threads on the same processing element. This is accomplished by the thread control interface mapping one or more processing cores to a given subset of ReadyThread queues, and then allocating the subset of threads to that subset of ReadyThread queues (by Queue ID). Such configuration guarantees that other threads (not belonging to the selected subset) will never compete for consuming resources within the selected subset of processing cores. The assignment of processing cores of the processing element to threads can also be updated dynamically to allow for dynamic configuration of the logical symmetric multi-processing (SMP) cores defined within the same processing element. The two extremes of the Logical SMP configurations are:
all processing cores are allocated to all threads; in this configuration the processing cores of the processing element behave like a single SMP Core; and
a processing core is allocated to one thread only; this configuration guarantees the absolute minimum latency to awake a thread, but it also results in inefficient resource consumption (since the one processing core will be idle when the thread is asleep).
   Other Logical SMP core configurations are possible. For example, FIG. 7 illustrates a configuration whereby the four processing cores of the processing element are configured as two logical SMP cores. Logical SMP Core 0 is allocated processing core 0. Logical SMP Core 1 is allocated processing cores 1,2,3.

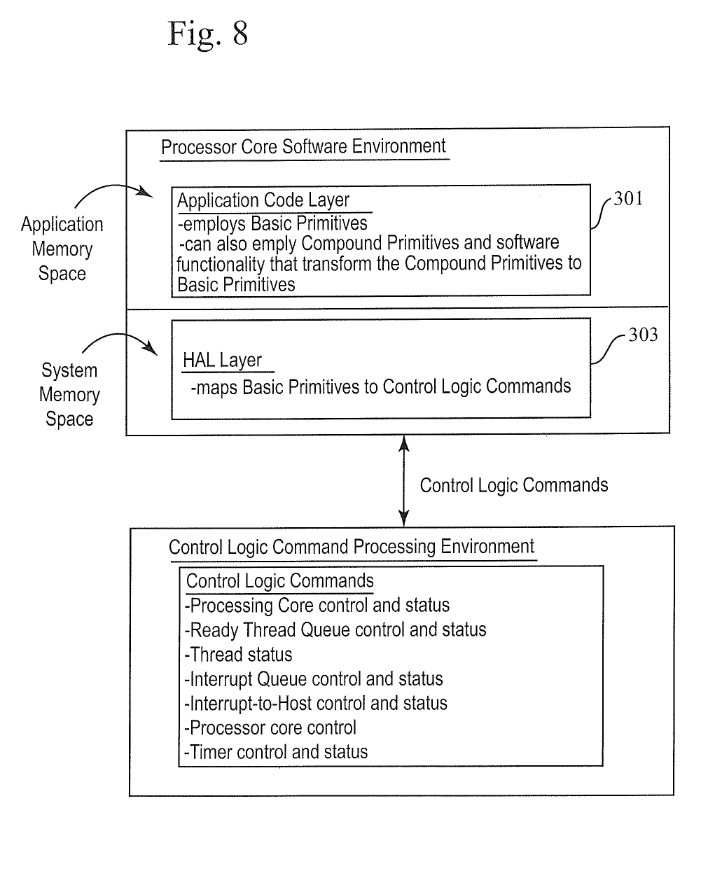

The mapping of threads to the processing cores of the processing element can also support assigning different priorities to the threads assigned to a logical SMP core (i.e., one or more processing cores of the processing element). More specifically, thread priority is specified by mapping multiple ReadyThread queues 237 to one or more processing cores, and by scheduling threads on those mapped queues depending on the desired priority. Note that the system may not provide any guarantee against thread starvation: a waiting ready thread in a lower priority queue could never be executed if the high priority queues always contain a waiting ready thread. FIG. 8 illustrates an example where the communication unit 211 maintains three ReadyThread queues 237A, 237B, 237C. ReadyThread queue 237A services the first logical SMP core (processor core 215A). ReadyThread queues 237B and 237C service the second logical SMP core (processor cores 215A, 215B, 215C). ReadyThread queue 237C stores thread IDs (and possibly other information) for high priority threads to be processed by the second logical SMP core, while ReadyThread queue 237B stores thread IDs (and possibly other information) for lower priority threads to be processed by the second logical SMP core. Threads are scheduled for execution on the processing cores of the second logical SMP core by popping a thread ID from one of the ReadyThread Queues 237B, 237C in a manner that gives priority to the high priority threads managed by the high priority ReadyThread Queue 237C.

In the preferred embodiment, the thread control interface maintained in the sys-bus register file 229 includes a control register labeled Logical.ReadyThread.Queue for each processing core 215A-215D. These control registers are logical constructs for realizing flexible thread scheduling amongst the processing cores. More specifically, each Logical.ReadyThread.Queue register encodes a configurable mapping that is defined between each processing core and the ReadyThread Queues 237 maintained by the communication unit 211.

The ReadyThread Queues 237 are preferably assigned ReadyThread Queue IDs and store 32-bit data words each corresponding to a unique ready thread. Bits 0-13 of the 32-bit word encodes a thread ID (Thread Number) as well as the ReadyThread Queue ID. Bit 14 of the 32-bit word distinguishes a valid Ready Thread notification from a Not Ready Thread Notification. Bit 15 of the 32-bit word is unused. Bits 16-18 of the 32-bit word identify the source of the thread awake request (e.g., “000” for NoC I/O event, “001” for Timer Event, “010” for a Multithread Control Interface event, and “011-111” not used). Bits 19-31 of the 32-bit word identify the Channel ID for case where a NOC I/O event is the source of the thread awake request.

### Communication Primitives

In the preferred embodiment as illustrated in FIG. 8, the software environment of the processor cores 215A-215D employs an application code layer 301 (preferably stored in designated application memory space of local memory 213) and a hardware abstraction layer 303 (preferably stored in designated system memory space of the local memory 213). The application code layer 301 employs basic communication primitives as well as compound primitives for carrying out communication between PEs and other peripheral blocks of the SOC. In the preferred embodiment, these communication primitives carry out read and write methods on communication channels as described below. For example, the Mux Select method and the Mux Select with Priority method as described below are preferably realized by such communication primitives. The application code layer 301 includes software functionality that transforms a given compound primitive into a corresponding set of basic primitives. Such functionality can be embodied as a part of a library that is dynamically linked at run-time to the execution thread(s) that employ the compound primitive. Alternatively, such functionality can be in-lined at compile time of the execution thread. The hardware abstraction layer 303 maps the basic primitives of the application code layer 301 to commands supported by the control logic 225 of the communication unit 211 and communicated over the system bus 227. The hardware abstraction layer is preferably embodied as a library that is dynamically linked at run-time to the execution thread(s) that employ the basic primitives.

### Software Development Environment

In the preferred embodiment, a software toolkit is provided to aid in programming the PEs 13 of the SOC 10 as described herein. The toolkit allows programmers to define logical programming constructs that are compiled by a compiler into run-time code and configuration data that are loaded onto the PEs 13 of the SOC 10 to carry out particular functions as designed by the programmers. In the preferred embodiment, the logical programming constructs supported by the software toolkit include Task Objects, Connectors and Channel Objects as described herein.

A Task object is a programming construct that defines threads processed on the PEs 13 of the SOC 10 and/or other sequences of operations carried out by other peripheral blocks of the SOC 10 that are connected to the NOC (collectively referred to as “threads” herein). A Task object also defines Connectors that represent routes for unidirectional point-to-point (P2P) communication over the NOC. A Task Object also defines Channel Objects that represent hardware resources of the system. Connectors and Channel Objects are assigned to threads to provide for communication of messages over the NOC between threads as described herein. A Task object may optionally define any composition of any number of Sub-task objects, which enables a tree-like hierarchical composition of Task objects.

Task objects are created by a programmer (or team of programmers) to carry out a set of distributed processes, and processed by the compiler to generate run-time representations of the threads of the Task objects. Such run-time representations of the threads of the task objects are then assigned in a distributed manner to the PEs 13 of the SOC 10 and/or carried out by other peripheral hardware blocks connected to the NOC. The assignment of threads to PEs and/or hardware blocks can be performed manually (or in a semi-automated manner under user control with the aid of a tool) or possibly in a fully-automated manner by the tool.

As described above, a thread is a sequence of operations that is processed on the PEs 13 and/or other sequences of operations carried out by other peripheral blocks of the SOC 10 that are connected to the NOC. From the perspective of a thread, a Channel object is either a Transmit Channel object, or a Receive Channel object. A thread can be associated with any mix of Receive and Transmit Channel objects. Many-to-one and one-to-many communication is possible and achieved by means of multiple Channel objects and the communication primitives as described herein.

In the preferred embodiment, each thread that is executed on a PE 13 shares a portion of the local memory 213 with all other threads executing on the same PE 13. This shared local memory address space can be used to store shared variables. Semaphores are used to achieve mutual exclusive access to the shared variables by the threads executing on the PE 13. Moreover, each thread that is executed on the PE 13 also has a private address space of the local memory 213. This private local memory address space is used to store the stack and the run-time code for the thread itself. It is also contemplated that dedicated hardware registers can be configured to protect the private local memory address space in order to generate access-errors when other threads access the private address space of a particular thread.

In the preferred embodiment, a thread appears like a ‘main( )’ method in the declaration of a Task object. The most typical case of a Thread will contain an infinite loop in which the particular function of the Task object is performed. For example, a Thread might receive a message on a Receive Channel object, do a classification on a packet header contained in the message, and forwarding the result on a Transmit channel object.

Threads processed by a PE 13 are executed by the processing cores of the PE 13. In the most basic configuration, each processing core of the PE 13 can run every thread. As is explained herein, it is also possible to configure the processing cores of a PE 13 as one or more logical Symmetrical Multi-Processors (SMPs) where the threads are assigned to the SMP(s) for execution. When a Thread is executed on a processing core, it runs until it explicitly triggers a thread-switch (Cooperative multi-threading). Channel objects are logical programming constructs that provide for communication of data as part of messages carried over the NOC between PEs 13 (or other peripheral blocks) of the SOC 10. Channel objects preferably include both Synchronous Channel objects and Asynchronous Channel object.

Synchronous Channel objects are used for flow-controlled communication over the NOC whereby the receiver Thread sends credits to the transmitter Thread to notify it that new data can be sent. The transmitter Thread only sends data when at least one credit is available. This is the preferred communication mode because it guarantees optimal and efficient utilization of the NoC (minimal backpressure generation). Importantly, the flow-control support is not exposed to the software programmer, who only needs to instantiate a Synchronous Channel object to take full advantage of the underlying flow-control. Nevertheless, it is preferably that interface calls be made available such that the software programmer can query the state of the flow control (for instance, to query the number of available credits) and enable therefore for more complex control over the communication.

Each end of a Synchronous Channel object has a Channel Size. For a Synchronous-type Transmit Channel object, the size specifies the maximum number of outstanding transmit requests that can be placed at the same time on Synchronous-type Transmit Channel object by issuing multiple non-blocking send primitives thereon. As an analogy, a Synchronous-type Transmit Channel object of size N can be compared with a hardware FIFO that has N entries. An outstanding transmit request of Synchronous-type Transmit Channel object will be executed by the transmitter PE 13 as soon as a credit has been received. If a credit has been received previously, then the transmitter PE 13 will transmit the message immediately when the thread invokes the send primitive. For a Synchronous-type Receive Channel object, the size specifies the maximum number of received messages that can be queued in the Receive Channel object. For each message to be received, a credit must have been sent previously. A received message remains queued in the Receive Channel object until a Thread invokes a read primitive on the Receive Channel object. The Channel Sizes of Transmit and Receive Channel objects are typically the same, but they can be different as long as the transmit Channel size is greater than or equal to the receive Channel size). The Channel Size is dimensioned based on expected communication latency between threads. Note that the Channel Size does not impact the code.

Asynchronous Channel objects are used for unchecked communication over the NOC where there is no flow-control. This may result in severe degradation of the NoC usage. For instance, if transmitter thread sends data when the receiver thread is not ready to receive, the message gets stalled on the NoC and several NoC links become unusuable for a relatively long interval. This can cause overload of these channels. They should usually be used when firmware communicates with a hardware block with known and predictable receive capabilities (e.g., shared memory requests). Thus, Asynchronous Channel objects are preferably used only in special cases, such as interrupts, MemCop messages, VCI messages.

In the preferred embodiment, a Task object is declared by the following components:
a task constructor declaration including zero or more Connectors and zero or more Sub-task declarations
   a Connector is used to connect Tasks together
   a SubTask Declaration is a pointer to another task
a declaration of zero or more Constants
a declaration of zero or more Shared Variables
   a declaration of zero or more Channel Objects as described herein; in the preferred embodiment, such Channel Objects include RxChannel objects, TxChannel objects, RxFifo objects, TxFifo objects, BufferPool objects, Mux objects, Timer objects, RxAny objects and TxAny objects;
   a declaration of a thread, which is declared as a main method; if a Task object has a main method, then it may have additional methods, which can be invoked from main or from each other. This allows a cleaner organization of the code; each method of the Task object will have access to all items declared inside the Task object; and
   a declaration of zero or more interrupt methods for the Task object.

A Connector is a communication interface for a Task object. It is either a transmit interface (TxConnector) or a receive interface (RxConnector). When two Task objects need to communicate with each other, their respective RxConnector and TxConnector are connected together inside the constructor of a top-level Task object. Or, when a Task has a Sub-Task, then a Connector can be “forwarded” to a corresponding Connector of the Sub-Task (again, this is done inside the constructor of a top-level Task object). The Task constructor declaration can include expressions that connect Connectors. For example, a TxConnector of one Task object can be connected to a RxConnector of another (or possibly the same) Task using the >> or << operator. The Task constructor declaration can also include expressions that forward Connectors. For example, a TxConnector of one Task object can be forwarded to a TxConnector of a SubTask using the=operator. Similarly, a RxConnector of one Task object can be forwarded to a RxConnector of a SubTask using the=operator. The compiler will parse the Task Constructor and will determine how many Sub Tasks are declared, what is the Task-hierarchy and how the various Task objects are connected together. Since this is all done at compile time, this is a static configuration, and all expressions must be constant expressions, so that the compiler can evaluate them at compile time.

A Task object can use constants and shared variables, i.e. variables that are shared with other Task objects. In this case, the Task objects that access a shared variable must execute on the same PE.

A Task object can also include a main method. If a main method is declared, then this represents a thread that will start execution during system initialization. A Task can also include an interrupt method, which will be invoked when an interrupt occurs.

There is a relation between Channel objects and Connectors. A Connector (a RxConnector or TxConnector) operates as a port or interface for a Task object. For each connection of a RxConnector to a TxConnector, the compiler will calculate a NoC routing header that encodes a route over the NOC between the two tasks. This route will depend on how the associated tasks are assigned to the PE's or other hardware blocks of the system). The mapping of Connectors to NOC headers can be performed as part of a static compilation function or part of a dynamic compilation function as need be.

Channel objects represent hardware resources of the SOC 10, for example one or more receive or transmit buffers of a node. Each Channel object consumes a location in the channel status memory 239. Furthermore, each Channel object consumes N locations in the buffer status memory 241 with N the size of the Channel object. The communication unit 211 maintains the status of the Channel objects and performs the actual receive and transmit of messages.

A TxChannel object behaves like a FIFO-queue. It contains requests for message-transmissions. The size of a TxChannel object defines the maximum number of messages that can be queued for transmission. The channel status memory 239 maintains a Count variable for each TxChannel object, which counts the number of free places in the transmit channel. It also maintains a threshold parameter (CountTh) for each TxChannel object, which is initialized by default to 1, but can be changed by the programmer. When a Write method on a TxChannel object is invoked, there are two scenarios:
If (Count>=CountTh) then there is room in the TxChannel object, and the message can be queued; in this case, the control logic 225 does not enforce a context-switch;
Otherwise, the TxChannel object is full and the control logic 225 enforces a context switch; the control logic 225 will reactivate the Thread if space in the TxChannel object becomes available, and the message will be enqueued in the TxChannel object.

A TxChannel object is “ready” when (Count>=CountTh), i.e. when there is room in the TxChannel object for another message to be transmitted. A TxChannel object has a type, which is specified as a template parameter in the Channel Declaration. A TxChannel object can be a single variable, or a one-dimensional array.

A RxChannel object also behaves like a FIFO-queue. It contains messages that have been received from the NoC but that are still waiting to be received by the Thread. The Size of a RxChannel object defines the maximum number of messages that can received from the NoC—prior to being received by the Thread. The channel status memory 239 maintains a Count variable for each RxChannel object, which counts the number of received messages from the NoC. It also maintains a threshold parameter (CountTh), which is initialized by default to 1, but can be changed by the programmer. When a Read method on a RxChannel object is invoked, there are two scenarios:
If (Count>=CountTh) then there are enough messages in the RxChannel object; in the case, the control logic 225 removes the oldest message from the RxChannel object and passes it to the Thread. A context-switch is not enforced;
Otherwise, there are not enough messages and the control logic 225 enforces a context switch. Note that there may be messages waiting in the RxChannel object, but not enough to have Count>=CountTh. The control logic 225 will re-activate the Thread if enough messages have been received from the NoC.

A RxChannel object is “ready” when (Count>=CountTh), i.e. when there are enough messages in the RxChannel object waiting to be received by the Thread using the Read method. For Synchronous-type RxChannel objects, a credit must be sent for every message that is to be received. The credit must contain the address in the local memory 213 where the received message is to be stored. After one, or multiple, initial credits have been sent, the actual data messages can be received. Typically, for every message that is received, another credit message is sent. Care must be taken that the received message has been consumed before its address is recycled in a credit: otherwise it may happen that the contents of the message gets over-written (since a fast transmitter may have various transmit messages already queued for transmission. These messages will automatically be transmitted by the PE 13 upon reception of a credit. A RxChannel object has a type, which is specified as a template parameter in the Channel Declaration. A RxChannel object can be a single variable, or a one-dimensional array.

Channel objects are initialized through the Bind method, which must be invoked before any other method. The Bind method connects a Channel object to a Connector of the same type, and also specifies the Channel Size. After the Bind has been completed, the Channel Object can be used. That is, for TxChannel objects, messages can be sent on this Channel object. And for RxChannel objects, credit messages can be sent after which messages can be received on an RxChannel object. As mentioned above, there are two Channel object types: RxChannel objects and TxChannel objects.

An implicit synchronization between a transmit Task and a receive Task takes place during binding of a Channel object. More specifically, the binding of TxChannel object causes an initialization message to be sent to the attached receiver Thread. The binding of the TxChannel object is non-blocking—i.e. there is no context switch. After the binding has completed, the TxChannel object can be used—i.e. messages can be sent to the TxChannel object using a Write method. The binding of a RxChannel object will block the Thread until the initialization message (from the TxChannel object's Bind) has been received. Since at this point it is known that the transmitter-side of the Channel object is ready (because it has sent the initialization message), the RxChannel object can be used—meaning that credits can be sent to the transmitter.

For RxChannel objects, Mux objects, RxAny objects and TxAny objects, the programmer is required to manually handle the transmission of credits and allocation of buffer addresses associated therewith. For RxFifo objects, TxFifo objects and Bufferpool objects, transmission of credits and allocation of buffer addresses are handled automatically as described below.

An RxFifo object derives all properties from a RxChannel object type, with the following additions:
it is associated with one Bufferpool object;
the Bind method will do the same as the bind of the RxChannel object, but also send a number of initial credits. For each credit, a free buffer address will be allocated from the BufferPool object;
upon reception of a message, the RxFifo object will automatically allocate a new free buffer from the Bufferpool object associated therewith and send that free buffer as a credit. If the associated Bufferpool object does not have enough free buffers available, then the RxFifo object will be queued in a circular list of RxFifo objects that are waiting to send credits.

A TxFifo object derives all properties from a TxChannel object type, with the following additions:
it is associated with one Bufferpool object;
the bind method will do the same as the bind of the TxChannel object;
upon transmission of a message, the TxFifo object will automatically release the address of the transmitted message back to the associated Bufferpool object. Note that the Bufferpool object is configured such that an address that is released back to the Bufferpool object will not be immediately available (otherwise the contents of a message that is pending transmission may be overwritten).

A Bufferpool object have the following properties:
the minimum pool size (i.e. the number of buffers in the pool) must equal the total size of all connected Channel objects; this provides one initial credit for each Receive Channel object;
the optimum pool size for performance equals the total size of all connected Transmit Channel objects plus the total size of all connected Receive Channel objects plus the typical number of “floating” buffers. A floating buffer is a buffer that is not under control of the buffer-pool and channels, but that is under control of the user:
   a buffer that is returned by a read method is “floating” until it is returned to the system by invoking a write or release method thereon; note that if the thread invokes two read methods, resulting in two floating buffers and then two writes, these operations cause a maximum of two floating buffers to be outstanding;
   a buffer that is returned by get method is “floating” until it is returned by invoking a write or release method thereon;
   when a “floating” buffer is returned back to the pool, it is guaranteed that it can not be re-allocated until N more buffers have been returned to the pool, with N=TotalTxChannelSize: the total size of all Transmit Channel object connected to the pool. This guarantees that a buffer will not be re-allocated until the corresponding message has been completely transmitted; and
   new buffers are allocated in a fair manner between competing receive FIFOs—and for each allocated buffer a credit message is sent.
      It is possible to specify a fixed offset in a receive buffer at which all received messages on a channel or FIFO are written. This allows a Thread to prepend a number of bytes in front of a message (like increasing the size of a received packet header) and send the new message on an output channel, without copying data in memory. This offset is specified using the Bind method on a RxChannel object or RxFifo object.

For TxChannel objects and TxFifo objects, it is possible to specify an offset inside a buffer, as well as the actual length of the message to be transmitted. This can be done on a per message basis. Note that this is different from RxChannel objects and RxFifo objects, where an offset is specified in the Bind method and this offset is used to all messages received on the RxChannel object/RxFifo object.

The Read and Write methods on the communication objects can involve any one of the blocking or non-blocking primitives described above. A blocking call always causes a thread-switch, and the thread is resumed once the corresponding I/O operation has completed. A non-blocking call returns immediately without switching thread if the requested communication event is available. Otherwise, the call becomes blocking.

The Timer object is similar to a RxChannel object, except that the control logic 225 generates messages at programmable time-interval, which can then be received using a Read method. Timer objects can also belong to a Mux object. The accuracy of the timers, or the timer clock-tick duration, is preferably a configurable parameter of the control logic 225, typically in the order of 10 uSec or slower.

Mux objects represent a special receive channel that is used to wait for events on multiple Channel objects. These client channels can be regular TxChannel objects, RxChannel object, TxFifo objects, RxFifo objects, Timer objects, or even other Mux objects. The Mux Select method (or the Mux Select with Priority method) is used to identify in an efficient manner which of the Channel object(s) that belong to the Mux object is “ready.” If at least one Channel object is “ready,” then the Mux Select method (or the Mux Select with Priority method) returns with a notification which Channel object is “ready.” If none of the Channel object(s) is ready, then the Thread will be blocked: i.e. a context switch occurs. As soon as one of the Channel objects of the Mux object becomes “ready,” then the control logic 225 wakes up the thread and provides notification on which Channel object is “ready.”

Channel objects are added to a Mux object through a Mux Add method. Once the Channel objects are added, the Mux Select method (or Mux Select with Priority method) can be used to determine the next Channel object that is “ready.” The set of Channel objects connected to a Mux object can be any mix of Transmit and Receive Channel objects (or FIFOs). For example, a Mux object with one RxFifo object and one TxFifo object can be used to receive data from the RxFifo object, process it and forward it to the TxFifo object. If the data is received faster than it can be transmitted, the data can be queued internally, or discarded. If the data is transmitted faster than it is received, then the Thread can internally generate data (like idle cells or frames) that it then transmits.

The RxAny object is functionally equivalent to a Mux object with only RxFifos—but it is much more efficient. Remember that with a Mux object, the programmer needs first to invoke the Select method, followed by a Read on the “ready” Channel object. With the RxAny object, the programmer only needs to invoke the Read method (thus omitting the invocation of the Mux Select method). The control logic 225 will implicitly perform the operations of the Mux Select method (using the recirculation queue, as explained below).

The TxAny object is functionally equivalent to a Mux object with only TxFifos—and is slightly more efficient. With the TxAny class, the programmer only needs to invoke the Write method (thus omitting the invocation of the Mux Select method). The control logic 225 will implicitly perform the operations of the Mux Select method (using the recirculation queue, as explained below).

The Mux Select method involves a particular Mux Channel object. A Mux Channel object is a logical construct that represents hardware resources that are associated with managing events from multiple Channel objects as described herein. In the preferred embodiment, these Channel objects can be a Receive Channel object, a Transmit Channel object, a Receive FIFO object, a Transmit FIFO object, a Timer object, a Mux Channel object, or any combination thereof. The purpose of the Mux Select method for a particular Mux Channel object is to receive notification when at least one of the Channel objects of the particular Mux Channel object is “ready.” For a Receive Channel object or a Receive FIFO object, “ready” means that a message is waiting in the respective Channel object to be received by a Read primitive. For a Transmit Channel object or a Transmit FIFO object, “ready” means that there is sufficient space in the respective Channel object for another message to be transmitted by a Write primitive. For a Timer object, “ready” means that a time-out event has occurred. And recursively, for a Mux Channel object, “ready” means that at least one of the Channel objects associated with the Mux Channel object is “ready.”

The communication unit 211 of each respective PE 13 maintains physical data structures that represent the Channel objects and Mux Channel objects utilized by the respective PE. In the preferred embodiment such data structures include the channel status memory 239 for storing the status of Channel objects and buffer status memory 241 for storing the status of each Mux Channel object (referred to herein as “Mux Channel Status memory”) as well as a FIFO buffer for each Mux Channel object (referred to herein as a “Mux Channel FIFO buffer”).

During initialization, a particular Channel object is added to a Mux Channel object by an Add operation whereby a flag is set as part of the Channel Status memory to indicate that the particular Channel object is part of a Mux Channel object and the Mux Channel ID of the Mux Channel object is stored in the channel status memory 239 as well. Furthermore, if during the Add operation, it is found that the particular Channel object is “ready”, then an internal event message for the particular Channel object is added to the recirculation queue 243 as described below. It is also possible to Add (or Remove) Channel objects to a Mux Channel object dynamically after initialization is complete.

When a thread invokes a Mux Select method for a particular Mux Channel object, the thread will be blocked until at least one of Channel objects belonging to the Mux Channel object is “ready.” A thread is blocked by a context switch in which another thread is activated. Thus, if none of the Channel objects belonging to the particular Mux Channel object is “ready” when the Mux Select Method for the particular Mux Channel object is invoked, then a context switch takes place. Subsequently, when at least one of the Channel objects belonging to the particular Mux Channel object becomes “ready,” the original thread can be activated again. If one of the Channel objects belonging to the particular Mux Channel object is “ready” when the Mux Select Method for the particular Mux Channel object is invoked, then no context switch needs to take place. In either case, the Mux Select methods returns an ID of the Channel object that is “ready” such that the thread can take appropriate action utilizing the “ready” Channel object. For example, in the case that the “ready” Channel object is a Receiver Channel object, the thread can perform a read method on the “ready” Receiver Channel object.

The Mux Channel Status memory stores a single Floating Channel ID for each Mux Channel object and corresponding Mux Channel FIFO buffer. The Floating Channel ID represents the “ready” Channel object identified for the most-recent invoked Mux Select Method on the corresponding Mux Channel Object. The Channel object pointed to by the Floating Channel ID is temporarily removed from the Mux Channel object and thus behaves like an independent Channel object. This allows the user to execute one operation (or multiple operations) on this Channel object. For example, in case this Channel object is a Receive Channel object, it is not known a priori if the user wants to invoke one or multiple Read operations on the Receive Channel object. Because this Channel object is temporarily independent of the Mux Channel, the user can invoke multiple Read operations. Note that since this Channel object is temporarily removed from the Mux Channel object, in the event that the Floating Channel object becomes “ready,” no event messages will be generated by the communication unit for this Mux Channel object and written to the recirculation queue 243 as described below.

The Mux Channel FIFO buffers each have a size that corresponds to the maximum number of Channel objects that can be added to the Mux Channel objects corresponding thereto. The content of a respective Mux Channel FIFO buffer identifies zero or more “ready” Channel objects that belong to the Mux Channel object corresponding thereto.

When a Channel object becomes “ready,” the control logic 225 generates an event message for the corresponding Mux Channel object to which it belongs and adds the event message to the recirculation queue 243. This event message will be generated only once for a given Channel object. That is, if multiple messages arrive in a given Receive Channel object, only one event message will be generated for the Mux Channel object and added to recirculation queue 243. The event message includes a Channel ID that identifies the “ready” Channel object as well as a Mux Channel ID that identifies the Mux Channel object to which the “ready” Channel object belongs and corresponding Mux Channel FIFO buffer.

The recirculation queue 243 is a FIFO queue of event messages that is processed by the control logic 243. In the preferred embodiment, the control logic 225 processes events from all its queues (one of these being the recirculation queue 243) in a round robin fashion. In processing an event message, the Channel ID of the event message (which identifies the “ready” Channel object) is added to the Mux Channel FIFO buffer corresponding to the Mux Channel ID of the event message.

When a thread invokes a Mux Select method on a particular Mux Channel object, the control logic 223 is invoked to perform a sequence of three operations. First, the Channel object pointed to by the Floating Channel ID corresponding to the particular Mux Channel object is added back to the particular Mux Channel object, which causes an event message to be sent to the recirculation queue 243 in case the Mux Channel Object is “ready.” Second, a read operation is invoked on the particular Mux Channel object, which reads a “ready” Channel ID from the top of the corresponding Mux Channel FIFO buffer. If there are no “ready” Channels available (i.e., the Mux FIFO buffer is empty), then the thread will be blocked until a “ready” Channel ID is written to the corresponding Mux Channel FIFO buffer. After reading the “ready” Channel ID from the corresponding Mux Channel FIFO buffer, the Channel ID for the “ready” Channel object is known. This Channel ID becomes the Floating Channel ID for the particular Mux Select Object. Lastly, the Mux Select method returns the Channel ID of the “ready” Channel object to the calling thread, which can then invoke operations on the “ready” Channel identified by the returned Channel ID.

Importantly, the operations of the Mux Select method on a particular Mux Channel object are fair between all the Channel objects that belong to the particular Mux Channel object. This stems from the fact that each Channel object will have at most one event message in the Mux Channel FIFO buffer associated with the particular Mux Channel object.

The Mux Select with Priority method involves different operations. More specifically, when a Mux Select with Priority method is invoked on a particular Mux Channel object, the entire Mux Channel FIFO queue corresponding to the particular Mux Channel object is flushed (i.e., emptied) such that all pending events are deleted. Then, all Channel objects that belong to the particular Mux Channel object are sequentially added back to the Mux Channel object in order of priority. If a Channel object is “ready” during the Add operation, an event message is generated for the Mux Channel object and added to the recirculation queue. Consequently, if any of the Channel objects are “ready” at the time of invoking the Mux Select with Priority method, the event messages will written to the recirculation queue in order of the priority for the Channel objects assigned to the particular Mux Channel object. A read operation is also invoked on the particular Mux Channel object, which reads a “ready” Channel ID from the top of the corresponding Mux Channel FIFO buffer. If there are no “ready” Channels available (i.e., the Mux FIFO buffer is empty), then the thread will be blocked until a “ready” Channel ID is written to the corresponding Mux Channel FIFO buffer. After reading the “ready” Channel ID from the corresponding Mux Channel FIFO buffer, the Channel ID for the “ready” Channel object is known. This Channel ID becomes the Floating Channel ID for the particular Mux Select Object. Lastly, the Mux Select method returns the Channel ID of the “ready” Channel object to the calling thread, which can then invoke operations on the “ready” Channel identified by the returned Channel ID.

The Mux Select method is typically very effective in repeated use (i.e., after initialization as part of an infinite loop) because the number of cycles required for execution is fixed and not dependent on the number of client channels. Furthermore, the Mux Select method provides fairness between all Channel objects belonging to the given Mux object.

The Mux Select with Priority method provides a strict priority scheme and its execution cost is proportional with the number of Channel objects belonging to the given Mux object. This is because the Mux Select with Priority method will inspect all Channel objects of the Mux object (preferably in the order that such objects were added) to determine the first Channel object that is ready. If no client channels are ready, then the Thread will block until at least one client channel becomes ready.

### NoC Bridge

In the preferred embodiment, the NoC bridge 37 of the SOC 10 cooperates with a Ser-Des block 36 to transmit and receive data over multiple high speed serial transmit and receive channels, respectively. For egress signals, the NoC bridge 37 outputs data words for transmission over respective serial transmit channels supported by block 36. Block 36 encodes and serializes the received data and transmits the serialized encoded data over the respective serial transmit channels. For ingress signals, block 36 receives the serialized encoded data over respective serial receive channels and deserializes and decodes the received data for output as received data words to the NoC bridge 37. The NoC bridge 37 and Ser-Des block 36 allow for interconnection of two or more SOCs 10 as illustrated in FIG. 9C. In the preferred embodiment, the NoC bridge 10 employs a microarchitecture as illustrated in FIGS. 9A AND 9B, which includes the NoC-node interface 151 for interfacing to the NoC as described herein.

For egress signals, the NoC-node interface 151 outputs the received NoC data words to a sequence of functional blocks 401-409 as shown in FIG. 9A. Block 401 performs aggregation of NoC data words, from up to four NoCs, of different priorities output by the NoC-node interface 151. The data from the four NoCs are combined by the block 401 into a single word 280 bits long, comprising 256 data bits and 24 control bits. The 280-bit words include four 64-bit words (one from NoC) each accompanied by 5 control bits that indicate the following:
2-bits to indicate SOM, EOM and Valid;
2-bits to indicate the NoC ID from which the data was received.
   The 280-bit words also include 4-bits that not linked logically to any of the data buses of the NoC directly, but rather, to buffers 411 at the receive side of the NoC bridge indicating congestion at the particular buffer. In this manner, these 4-bits provide an inband notification transmitted across the serial channels supported by the Ser-Des block 36 to the other NoC bridge interfaced thereto in order to trigger termination of transmission at the other NoC bridge.

Block 403 scrambles the 280 bit data word (generated by Block 401), with the standard x̂43+1 scrambler, and creates a 20 bit gap at the end of it, for use by the following block 405, which inserts a 10 bit wide ECC and additionally the 10-bit wide complement ECC (labeled E̅C̅C̅). The E̅C̅C̅ is needed so that the physical layer signal has equal number of transitions; since scrambling of the data has already been performed by the time the data reaches Block 405. It is crucial to realize that E̅C̅C̅ does not play any part in any error correction process. ONLY the ECC shall be used for error correction. The scrambler in Block 403, is stopped for the 20-bit gap (i.e., the 20 bit gap is not scrambled), and the state is saved for continuing the scrambling operation on the next block. Note that the x̂43+1 scrambler is a self-synchronizing, multiplicative scrambler, that is used to scramble data when gaps and frequent stops are expected, such as when packetizing data. The Block 405 generates a 10-bit ECC and it's 10-bit complement E̅C̅C̅ for the 280-bit scrambled word. In the preferred embodiment, a SECDED Hamming code is used for the 10-bit ECC. Thus the output of Block 405 is a 300 bit wide word. It should also be noted that each functional block (such as 401, 403, 405 and all else) preferably includes interface buffering as necessary for storage requirements for the processing state machines, and also for rate adaptation.

Block 405 formats the 300-bit block as per the format (280-bit scrambled data, 10 bit ECC, 10 bit ECC) and stores the 300-bit block in a buffer 405A as shown in FIG. 9B.

Block 407 processes a 300-bit block input from the buffer 405A by demultiplexing the 300-bit block into 30 10-bit words and then forwarding the 30 10-bit words to four output queues for block 409.

Framer block 409 includes framer logic 409 that reads out 10-bit data words from the respective output queues of the block 407 and inserts framing words into the respective output word streams as dictated by a predetermined framing protocol. In the preferred embodiment, the framing protocol employs a unique 160-bit framing word (comprised of 16×10-bit words for the Serializer) for every 48,000 10-bit data words. The 16×10-bit words of the four output data streams generated by the framer logic 413A 409 is stored in respective output buffers 409A-409D for output to the Ser-Des block 36 for transmission over four serial transmit links supported by block 36.

For ingress signals, the Ser-Des block 36 supplies 10-bit words of the four incoming data streams received at the Ser-Des block 36 to a sequence of functional blocks 411-419 as shown in FIG. 9A. Such functionality embodies ingress signal processing that is complementary to the egress signal processing of functional blocks 401-409 as described herein. More specifically, block 411 buffers the received 10-bits words of the four data streams provided by the Ser-Des block 36 and synchronizes to the framing word carried by the four data streams. The 10-bit data words of the four data streams (less the 160-bit framing word) are output to the Multiplexing Block 413, to be further forwarded followed to the ECC, and E̅C̅C̅ termination block 415, and block 417 for descrambling operations.

The 10-bit deserialized data words (excepting the framing words 16×10=160 bits) are output to block 413 that multiplexes the received 10-bit parallel data words into 300-bit words, thereby reconstructing the 300-bit words generated by the block formatter 405 at the transmitter NoC bridge. Buffer at the input of Block 415 stores the 300-bit words generated by the multiplexer block 413. Block 415 performs the ECC check on the 300-bit words based on only the ECC, and then discards both the ECC and the E̅C̅C̅, thereby performing a de-gapping operation, and forwards the resulting 280 bit words on to block number 417 for the de-scrambling operation. The descrambler block 417 includes the descrambler logic block for descrambling the 280-bit words supplied thereto. In the preferred embodiment, the descrambler logic blocks carry out a descrambling operation that is complementary to the scrambling operations. Block 419 disaggregates the 280-bit words that are descrambled by Block 417, and also verified and possibly corrected by the block 415, into corresponding four 64-bit words and accompanying 5 control bits as described herein. The 4 control bits that are used for inband notification of congestion are analyzed. If the 4 bits indicate congestion, block 419 triggers termination of transmission by the NoC bridge by disabling the egress signal processing of blocks 401-409. Block 419 provides the NoC data words that result from such deaggregation to the NoC-Node interface 151 for transmission over the NoC as described herein.

It is key that the scrambling operation is performed before ECC generation, and correspondingly, in the other direction, the ECC checking and termination be performed before descrambling, since otherwise, a single bit error in the descrambling process, as result of error multiplication, may render the ECC useless.

There have been described and illustrated herein several embodiments of a system-on-a-chip employing a parallel processing architecture suitable for implementing a wide variety of functions, including telecommunications functionality that is necessary and/or desirable in next generation telecommunications networks. While particular embodiments of the invention have been described, it is not intended that the invention be limited thereto, as it is intended that the invention be as broad in scope as the art will allow and that the specification be read likewise. Thus, while particular message formats, bus topologies and routing mechanisms have been disclosed for the on-chip network, it will be appreciated that other message formats, bus topologies and routing mechanisms can be used as well. In addition, while a particular multi-processor architecture of the processing elements of the system-on-a-chip have been disclosed, it will be understood that other architectures can be used. Furthermore, while particular programming constructs and tools have been discloses for programming the processing elements of the system-on-a-chip, it will be understood that other programming constructs and tools can be similarly used. It will therefore be appreciated by those skilled in the art that yet other modifications could be made to the provided invention without deviating from its spirit and scope as claimed.

What is claimed is:

1. A multi-chip system comprising:
at least two integrated circuits each including a) an array of nodes linked by an on-chip communication network, and b) a bridge interface, operably coupled to the on-chip communication network, for communicating data over at least one physical communication channel linking the integrated circuits;
wherein the bridge interface of a respective integrated circuit transparently routes egress messages received from the on-chip communication network of the respective integrated circuit over the at least one physical communication channel linking the integrated circuits, and the bridge interface of the respective integrated circuit transparently routes ingress messages received from the at least one physical communication channel linking the integrated circuits to the on-chip communication network of the respective integrated circuit.

2. A multi-chip system according to claim 1, wherein:
the bridge interface of the respective integrated circuit transparently routes egress messages according to routing information contained in the header of the egress messages.

3. A multi-chip system according to claim 1, wherein:
the bridge interface of the respective integrated circuit transparently routes ingress messages according to routing information contained in the header of the ingress messages.

4. A multi-chip system according to claim 1, wherein:
the nodes of the first and second integrated circuits include an array of programmable processing elements, wherein each processing element includes a plurality of processing cores and a local memory.

5. A multi-chip system according to claim 1, wherein:
the nodes of the first and second integrated circuits include a peripheral block that generates clock signals based on recovered embedded timing information carried in input messages, the input messages carrying data packets representing standard telecommunication circuit signals.

6. A multi-chip system according to claim 1, wherein:
the nodes of the first and second integrated circuits include a peripheral block for buffering incoming data packets supplied by at least one communication interface coupled thereto and for buffering outgoing data packets for output to the at least one communication interface coupled thereto.

7. A multi-chip system according to claim 6, wherein:
the incoming and outgoing data packets are Ethernet data packets.

8. A multi-chip system according to claim 1, wherein:
the nodes of the first and second integrated circuits include a peripheral block that receives and transmits serial data that is part of ingress or egress SONET frames.

9. A multi-chip system according to claim 1, wherein:
the nodes of the first and second integrated circuits include a peripheral block that supports buffering of data packets in an external memory.

10. A multi-chip system according to claim 1, wherein:
the at least one physical communication channel comprises a plurality of serial communication channels.

11. An integrated circuit comprising:
an array of nodes linked by an on-chip communication network; and
a bridge interface, operably coupled to the on-chip communication network, for communicating data over at least one physical communication channel that links the integrated circuit to at least one other integrated circuit;
wherein the bridge interface transparently routes egress messages received from the on-chip communication network over the at least one physical communication channel linking to the at least one other integrated circuit, and the bridge interface transparently routes ingress messages received from the at least one physical communication channel linking the at least one other integrated circuit to the on-chip communication network.

12. An integrated circuit according to claim 11, wherein:
the bridge interface transparently routes egress messages according to routing information contained in the header of the egress messages.

13. An integrated circuit according to claim 11, wherein:
the bridge interface transparently routes ingress messages according to routing information contained in the header of the ingress messages.

14. An integrated circuit according to claim 11, wherein:
the nodes include an array of programmable processing elements, wherein each processing element includes a plurality of processing cores and a local memory.

15. An integrated circuit according to claim 11, wherein:
the nodes include a peripheral block that generates clock signals based on recovered embedded timing information carried in input messages, the input messages carrying data packets representing standard telecommunication circuit signals.

16. An integrated circuit according to claim 11, wherein:
the nodes include a peripheral block for buffering incoming data packets supplied by at least one communication interface coupled thereto and for buffering outgoing data packets for output to the at least one communication interface coupled thereto.

17. An integrated circuit according to claim 16, wherein:
the incoming and outgoing data packets are Ethernet data packets.

18. An integrated circuit according to claim 11, wherein:
the nodes include a peripheral block that receives and transmits serial data that is part of ingress or egress SONET frames.

19. An integrated circuit according to claim 11, wherein:
the nodes include a peripheral block that supports buffering of data packets in an external memory.

20. An integrated circuit according to claim 11, wherein:
the at least one physical communication channel comprises a plurality of serial communication channels.
